(19) United States
(12) Patent Application Publication
(10) Pub. No.: US 2025/0048316 A1
(43) Pub. Date: Feb. 6, 2025

(54) PAIRED WINDOWS FOR SIDELINK POSITIONING REFERENCE SIGNALS

(71) Applicant: QUALCOMM Incorporated, San Diego, CA (US)

(72) Inventors: Jing DAI, Beijing (CN); Chao WEI, Beijing (CN); Hao XU, Beijing (CN)

(21) Appl. No.: 18/719,188

(22) PCT Filed: Dec. 23, 2021
(86) PCT No.: PCT/CN2021/140790

§ 371 Date: Jun. 12, 2024

(51) Int. Cl. H04W 64/00; G01S 5/02; H04W 72/0446; H04W 72/25; H04W 92/18

(52) U.S. Cl. CPC H04W 64/00; G01S 5/0205; H04W 72/0446; H04W 72/25; H04W 92/18

(57) ABSTRACT

In an aspect, a user equipment (UE) may receive indications of positioning resources of a positioning resource pool, wherein the positioning resource pool includes a first positioning resource window having a first set of one or more contiguous positioning resources, a second positioning resource window having a second set of one or more contiguous positioning resources, and a third positioning resource window having a third set of one or more contiguous positioning resources extending between an end of the first positioning resource window and a start of the second positioning resource window. The UE may transmit a first positioning reference signal (PRS) on a first positioning resource reserved from the first positioning resource window. The UE may transmit a second PRS on a second positioning resource reserved from the second positioning resource window.

### CROSS-REFERENCE TO RELATED APPLICATIONS

The present Application for Patent is a national stage application, filed under 35 U.S.C. § 371, of International Patent Application No. PCT/CN2021/140790, entitled, “PAIRED WINDOWS FOR SIDELINK POSITIONING REFERENCE SIGNALS”, filed Dec. 23, 2021, which is assigned to the assignee hereof and is expressly incorporated herein by reference in its entirety.

### BACKGROUND OF THE DISCLOSURE

### 1. Field of the Disclosure

Aspects of the disclosure relate generally to wireless communications.

### 2. Description of the Related Art

Wireless communication systems have developed through various generations, including a first-generation analog wireless phone service (1G), a second-generation (2G) digital wireless phone service (including interim 2.5G and 2.75G networks), a third-generation (3G) high speed data, Internet-capable wireless service and a fourth-generation (4G) service (e.g., Long Term Evolution (LTE) or WiMax). There are presently many different types of wireless communication systems in use, including cellular and personal communications service (PCS) systems. Examples of known cellular systems include the cellular analog advanced mobile phone system (AMPS), and digital cellular systems based on code division multiple access (CDMA), frequency division multiple access (FDMA), time division multiple access (TDMA), the Global System for Mobile communications (GSM), etc.

A fifth generation (5G) wireless standard, referred to as New Radio (NR), enables higher data transfer speeds, greater numbers of connections, and better coverage, among other improvements. The 5G standard, according to the Next Generation Mobile Networks Alliance, is designed to provide higher data rates as compared to previous standards, more accurate positioning (e.g., based on reference signals for positioning (RS-P), such as downlink, uplink, or sidelink positioning reference signals (PRS)) and other technical enhancements.

Leveraging the increased data rates and decreased latency of 5G, among other things, vehicle-to-everything (V2X) communication technologies are being implemented to support autonomous driving applications, such as wireless communications between vehicles, between vehicles and the roadside infrastructure, between vehicles and pedestrians, etc.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

In an aspect, a method of wireless communication performed by a user equipment (UE) includes receiving indications of positioning resources of a positioning resource pool, wherein the positioning resource pool includes a first positioning resource window having a first set of one or more contiguous positioning resources, a second positioning resource window having a second set of one or more contiguous positioning resources, and a third positioning resource window having a third set of one or more contiguous positioning resources extending between an end of the first positioning resource window and a start of the second positioning resource window; transmitting a first positioning reference signal (PRS) on a first positioning resource reserved from the first positioning resource window; and transmitting a second PRS on a second positioning resource reserved from the second positioning resource window.

In an aspect, a user equipment (UE) includes a memory; at least one transceiver; and at least one processor communicatively coupled to the memory and the at least one transceiver, the at least one processor configured to: receive, via the at least one transceiver, indications of positioning resources of a positioning resource pool, wherein the positioning resource pool includes a first positioning resource window having a first set of one or more contiguous positioning resources, a second positioning resource window having a second set of one or more contiguous positioning resources, and a third positioning resource window having a third set of one or more contiguous positioning resources extending between an end of the first positioning resource window and a start of the second positioning resource window; transmit, via the at least one transceiver, a first positioning reference signal (PRS) on a first positioning resource reserved from the first positioning resource window; and transmit, via the at least one transceiver, a second PRS on a second positioning resource reserved from the second positioning resource window.

In an aspect, a user equipment (UE) includes means for receiving indications of positioning resources of a positioning resource pool, wherein the positioning resource pool includes a first positioning resource window having a first set of one or more contiguous positioning resources, a second positioning resource window having a second set of one or more contiguous positioning resources, and a third positioning resource window having a third set of one or more contiguous positioning resources extending between an end of the first positioning resource window and a start of the second positioning resource window; means for transmitting a first positioning reference signal (PRS) on a first positioning resource reserved from the first positioning resource window; and means for transmitting a second PRS on a second positioning resource reserved from the second positioning resource window.

In an aspect, a non-transitory computer-readable medium stores computer-executable instructions that, when executed by a user equipment (UE), cause the UE to: receive indications of positioning resources of a positioning resource pool, wherein the positioning resource pool includes a first positioning resource window having a first set of one or more contiguous positioning resources, a second positioning resource window having a second set of one or more contiguous positioning resources, and a third positioning resource window having a third set of one or more contiguous positioning resources extending between an end of the first positioning resource window and a start of the second positioning resource window; transmit a first positioning reference signal (PRS) on a first positioning resource reserved from the first positioning resource window; and transmit a second PRS on a second positioning resource reserved from the second positioning resource window.

Other objects and advantages associated with the aspects disclosed herein will be apparent to those skilled in the art based on the accompanying drawings and detailed description.

### BRIEF DESCRIPTION OF THE DRAWINGS

The accompanying drawings are presented to aid in the description of various aspects of the disclosure and are provided solely for illustration of the aspects and not limitation thereof.

FIG. 1 illustrates an example wireless communications system according to aspects of the disclosure.

FIGS. 2A and 2B illustrate example wireless network structures according to aspects of the disclosure.

FIG. 3 is a block diagram illustrating various components of an example user equipment (UE), according to aspects of the disclosure.

FIG. 4 is a diagram illustrating an example frame structure according to aspects of the disclosure.

FIG. 5 illustrates basic sidelink transmission scenarios according to aspects of the disclosure.

FIG. 6 shows example sidelink deployment scenarios according to aspects of the disclosure.

FIG. 7 shows an example resource pool according to aspects of the disclosure.

FIG. 8 depicts an example configuration of symbols of a sidelink resource for a slot of a sub-channel according to aspects of the disclosure.

FIG. 9 is a timing diagram showing an example of Mode 2 resource allocation according to aspects of the disclosure.

FIG. 10 illustrates signals exchanged during a multi-round-trip-time (RTT) positioning procedure between sidelink UEs according to aspects of the disclosure.

FIG. 11 illustrates signals exchanged during a double-sided RTT positioning procedure between sidelink UEs according to aspects of the disclosure.

FIG. 12 illustrates signals exchanged and measured during a two-phase, reception-only time difference of arrival (Rx-TDoA) positioning procedure according to aspects of the disclosure.

FIG. 13 illustrates signals exchanged and measured during a two-phase, transmission-only time difference of arrival (Tx-TDoA) positioning procedure according to aspects of the disclosure.

FIG. 14 illustrates signals exchanged and measured during a two-phase, elliptic positioning procedure according to aspects of the disclosure.

FIG. 15 depicts a sidelink resource pool including a resource pool for positioning according to aspects of the disclosure.

FIG. 16 shows example slot configurations for sidelink positioning reference signal (SL-PRS) symbols according to aspects of the disclosure.

FIG. 17 shows examples for pairing SL-PRS resources allocated to the same UE according to aspects of the disclosure.

FIG. 18 depicts an example sidelink resource pool including a resource pool for positioning according to aspects of the disclosure.

FIG. 19 depicts a sidelink resource pool including multiple resource pools for positioning that occur within a sidelink resource pool according to aspects of the disclosure.

FIG. 20 illustrates an example method of wireless communication performed by a UE in accordance with aspects of the disclosure.

### DETAILED DESCRIPTION

Aspects of the disclosure are provided in the following description and related drawings directed to various examples provided for illustration purposes. Alternate aspects may be devised without departing from the scope of the disclosure. Additionally, well-known elements of the disclosure will not be described in detail or will be omitted so as not to obscure the relevant details of the disclosure.

The words “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

Those of skill in the art will appreciate that the information and signals described below may be represented using any of a variety of different technologies and techniques. For example, data, instructions, commands, information, signals, bits, symbols, and chips that may be referenced throughout the description below may be represented by voltages, currents, electromagnetic waves, magnetic fields or particles, optical fields or particles, or any combination thereof, depending in part on the particular application, in part on the desired design, in part on the corresponding technology, etc.

Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, the sequence(s) of actions described herein can be considered to be embodied entirely within any form of non-transitory computer-readable storage medium having stored therein a corresponding set of computer instructions that, upon execution, would cause or instruct an associated processor of a device to perform the functionality described herein. Thus, the various aspects of the disclosure may be embodied in a number of different forms, all of which have been contemplated to be within the scope of the claimed subject matter. In addition, for each of the aspects described herein, the corresponding form of any such aspects may be described herein as, for example, “logic configured to” perform the described action.

As used herein, the terms “user equipment” (UE), “vehicle UE” (V-UE), “pedestrian UE” (P-UE), and “base station” are not intended to be specific or otherwise limited to any particular radio access technology (RAT), unless otherwise noted. In general, a UE may be any wireless communication device (e.g., vehicle on-board computer, vehicle navigation device, mobile phone, router, tablet computer, laptop computer, asset locating device, wearable (e.g., smartwatch, glasses, augmented reality (AR)/virtual reality (VR) headset, etc.), vehicle (e.g., automobile, motorcycle, bicycle, etc.), Internet of Things (IoT) device, etc.) used by a user to communicate over a wireless communications network. A UE may be mobile or may (e.g., at certain times) be stationary, and may communicate with a radio access network (RAN). As used herein, the term “UE” may be referred to interchangeably as a “mobile device,” an “access terminal” or “AT,” a “client device,” a “wireless device,” a “subscriber device,” a “subscriber terminal,” a “subscriber station,” a “user terminal” or UT, a “mobile terminal,” a “mobile station,” or variations thereof.

A V-UE is a type of UE and may be any in-vehicle wireless communication device, such as a navigation system, a warning system, a heads-up display (HUD), an on-board computer, an in-vehicle infotainment system, an automated driving system (ADS), an advanced driver assistance system (ADAS), etc. Alternatively, a V-UE may be a portable wireless communication device (e.g., a cell phone, tablet computer, etc.) that is carried by the driver of the vehicle or a passenger in the vehicle. The term “V-UE” may refer to the in-vehicle wireless communication device or the vehicle itself, depending on the context. A P-UE is a type of UE and may be a portable wireless communication device that is carried by a pedestrian (i.e., a user that is not driving or riding in a vehicle). Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, wireless local area network (WLAN) networks (e.g., based on Institute of Electrical and Electronics Engineers (IEEE) 802.11, etc.) and so on.

A base station may operate according to one of several RATs in communication with UEs depending on the network in which it is deployed, and may be alternatively referred to as an access point (AP), a network node, a NodeB, an evolved NodeB (eNB), a next generation eNB (ng-eNB), a New Radio (NR) Node B (also referred to as a gNB or gNodeB), etc. A base station may be used primarily to support wireless access by UEs including supporting data, voice and/or signaling connections for the supported UEs. In some systems a base station may provide purely edge node signaling functions while in other systems it may provide additional control and/or network management functions.

A communication link through which UEs can send signals to a base station is called an uplink (UL) channel (e.g., a reverse traffic channel, a reverse control channel, an access channel, etc.). A communication link through which the base station can send signals to UEs is called a downlink (DL) or forward link channel (e.g., a paging channel, a control channel, a broadcast channel, a forward traffic channel, etc.). As used herein the term traffic channel (TCH) can refer to either an UL/reverse or DL/forward traffic channel.

The term “base station” may refer to a single physical transmission-reception point (TRP) or to multiple physical TRPs that may or may not be co-located. For example, where the term “base station” refers to a single physical TRP, the physical TRP may be an antenna of the base station corresponding to a cell (or several cell sectors) of the base station. Where the term “base station” refers to multiple co-located physical TRPs, the physical TRPs may be an array of antennas (e.g., as in a multiple-input multiple-output (MIMO) system or where the base station employs beamforming) of the base station. Where the term “base station” refers to multiple non-co-located physical TRPs, the physical TRPs may be a distributed antenna system (DAS) (a network of spatially separated antennas connected to a common source via a transport medium) or a remote radio head (RRH) (a remote base station connected to a serving base station). Alternatively, the non-co-located physical TRPs may be the serving base station receiving the measurement report from the UE and a neighbor base station whose reference radio frequency (RF) signals the UE is measuring. Because a TRP is the point from which a base station transmits and receives wireless signals, as used herein, references to transmission from or reception at a base station are to be understood as referring to a particular TRP of the base station.

In some implementations that support positioning of UEs, a base station may not support wireless access by UEs (e.g., may not support data, voice, and/or signaling connections for UEs), but may instead transmit reference RF signals to UEs to be measured by the UEs and/or may receive and measure signals transmitted by the UEs. Such base stations may be referred to as positioning beacons (e.g., when transmitting RF signals to UEs) and/or as location measurement units (e.g., when receiving and measuring RF signals from UEs).

An “RF signal” comprises an electromagnetic wave of a given frequency that transports information through the space between a transmitter and a receiver. As used herein, a transmitter may transmit a single “RF signal” or multiple “RF signals” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal. As used herein, an RF signal may also be referred to as a “wireless signal” or simply a “signal” where it is clear from the context that the term “signal” refers to a wireless signal or an RF signal.

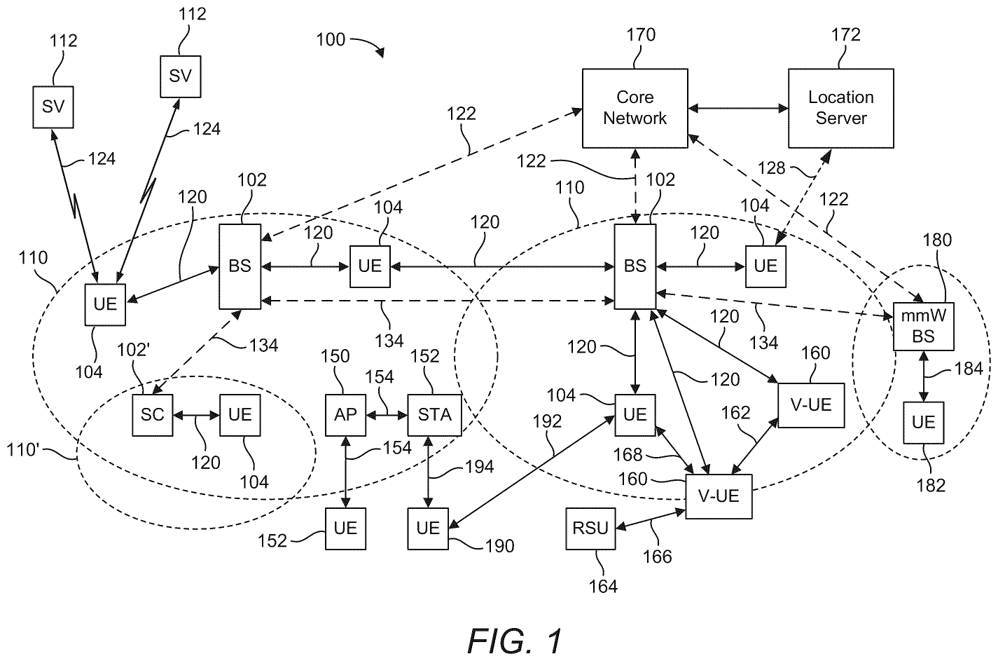

FIG. 1 illustrates an example wireless communications system 100, according to aspects of the disclosure. The wireless communications system 100 (which may also be referred to as a wireless wide area network (WWAN)) may include various base stations 102 (labelled “BS”) and various UEs 104. The base stations 102 may include macro cell base stations (high power cellular base stations) and/or small cell base stations (low power cellular base stations). In an aspect, the macro cell base stations 102 may include eNBs and/or ng-eNBs where the wireless communications system 100 corresponds to an LTE network, or gNBs where the wireless communications system 100 corresponds to a NR network, or a combination of both, and the small cell base stations may include femtocells, picocells, microcells, etc.

The base stations 102 may collectively form a RAN and interface with a core network 170 (e.g., an evolved packet core (EPC) or 5G core (5GC)) through backhaul links 122, and through the core network 170 to one or more location servers 172 (e.g., a location management function (LMF) or a secure user plane location (SUPL) location platform (SLP)). The location server(s) 172 may be part of core network 170 or may be external to core network 170. A location server 172 may be integrated with a base station 102. A UE 104 may communicate with a location server 172 directly or indirectly. For example, a UE 104 may communicate with a location server 172 via the base station 102 that is currently serving that UE 104. A UE 104 may also communicate with a location server 172 through another path, such as via an application server (not shown), via another network, such as via a WLAN access point (AP) (e.g., AP 150 described below), and so on. For signaling purposes, communication between a UE 104 and a location server 172 may be represented as an indirect connection (e.g., through the core network 170, etc.) or a direct connection (e.g., as shown via direct connection 128), with the intervening nodes (if any) omitted from a signaling diagram for clarity.

In addition to other functions, the base stations 102 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace, RAN information management (RIM), paging, positioning, and delivery of warning messages. The base stations 102 may communicate with each other directly or indirectly (e.g., through the EPC/5GC) over backhaul links 134, which may be wired or wireless.

The base stations 102 may wirelessly communicate with the UEs 104. Each of the base stations 102 may provide communication coverage for a respective geographic coverage area 110. In an aspect, one or more cells may be supported by a base station 102 in each geographic coverage area 110. A “cell” is a logical communication entity used for communication with a base station (e.g., over some frequency resource, referred to as a carrier frequency, component carrier, carrier, band, or the like), and may be associated with an identifier (e.g., a physical cell identifier (PCI), an enhanced cell identifier (ECI), a virtual cell identifier (VCI), a cell global identifier (CGI), etc.) for distinguishing cells operating via the same or a different carrier frequency. In some cases, different cells may be configured according to different protocol types (e.g., machine-type communication (MTC), narrowband IoT (NB-IoT), enhanced mobile broadband (eMBB), or others) that may provide access for different types of UEs. Because a cell is supported by a specific base station, the term “cell” may refer to either or both the logical communication entity and the base station that supports it, depending on the context. In some cases, the term “cell” may also refer to a geographic coverage area of a base station (e.g., a sector), insofar as a carrier frequency can be detected and used for communication within some portion of geographic coverage areas 110.

While neighboring macro cell base station 102 geographic coverage areas 110 may partially overlap (e.g., in a handover region), some of the geographic coverage areas 110 may be substantially overlapped by a larger geographic coverage area 110. For example, a small cell base station 102′ (labelled “SC” for “small cell”) may have a geographic coverage area 110′ that substantially overlaps with the geographic coverage area 110 of one or more macro cell base stations 102. A network that includes both small cell and macro cell base stations may be known as a heterogeneous network. A heterogeneous network may also include home eNBs (HeNBs), which may provide service to a restricted group known as a closed subscriber group (CSG).

The communication links 120 between the base stations 102 and the UEs 104 may include uplink (also referred to as reverse link) transmissions from a UE 104 to a base station 102 and/or downlink (DL) (also referred to as forward link) transmissions from a base station 102 to a UE 104. The communication links 120 may use MIMO antenna technology, including spatial multiplexing, beamforming, and/or transmit diversity. The communication links 120 may be through one or more carrier frequencies. Allocation of carriers may be asymmetric with respect to downlink and uplink (e.g., more or less carriers may be allocated for downlink than for uplink).

The wireless communications system 100 may further include a WLAN access point (AP) 150 in communication with WLAN stations (STAs) 152 via communication links 154 in an unlicensed frequency spectrum (e.g., 5 GHz). When communicating in an unlicensed frequency spectrum, the WLAN STAs 152 and/or the WLAN AP 150 may perform a clear channel assessment (CCA) or listen before talk (LBT) procedure prior to communicating in order to determine whether the channel is available.

The small cell base station 102′ may operate in a licensed and/or an unlicensed frequency spectrum. When operating in an unlicensed frequency spectrum, the small cell base station 102′ may employ LTE or NR technology and use the same 5 GHz unlicensed frequency spectrum as used by the WLAN AP 150. The small cell base station 102′, employing LTE/5G in an unlicensed frequency spectrum, may boost coverage to and/or increase capacity of the access network. NR in unlicensed spectrum may be referred to as NR-U. LTE in an unlicensed spectrum may be referred to as LTE-U, licensed assisted access (LAA), or MulteFire.

The wireless communications system 100 may further include a mmW base station 180 that may operate in millimeter wave (mmW) frequencies and/or near mmW frequencies in communication with a UE 182. Extremely high frequency (EHF) is part of the RF in the electromagnetic spectrum. EHF has a range of 30 GHz to 300 GHz and a wavelength between 1 millimeter and 10 millimeters. Radio waves in this band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band have high path loss and a relatively short range. The mmW base station 180 and the UE 182 may utilize beamforming (transmit and/or receive) over a mmW communication link 184 to compensate for the extremely high path loss and short range. Further, it will be appreciated that in alternative configurations, one or more base stations 102 may also transmit using mmW or near mmW and beamforming. Accordingly, it will be appreciated that the foregoing illustrations are merely examples and should not be construed to limit the various aspects disclosed herein.

Transmit beamforming is a technique for focusing an RF signal in a specific direction. Traditionally, when a network node (e.g., a base station) broadcasts an RF signal, it broadcasts the signal in all directions (omni-directionally). With transmit beamforming, the network node determines where a given target device (e.g., a UE) is located (relative to the transmitting network node) and projects a stronger downlink RF signal in that specific direction, thereby providing a faster (in terms of data rate) and stronger RF signal for the receiving device(s). To change the directionality of the RF signal when transmitting, a network node can control the phase and relative amplitude of the RF signal at each of the one or more transmitters that are broadcasting the RF signal. For example, a network node may use an array of antennas (referred to as a “phased array” or an “antenna array”) that creates a beam of RF waves that can be “steered” to point in different directions, without actually moving the antennas. Specifically, the RF current from the transmitter is fed to the individual antennas with the correct phase relationship so that the radio waves from the separate antennas add together to increase the radiation in a desired direction, while cancelling to suppress radiation in undesired directions.

Transmit beams may be quasi-co-located, meaning that they appear to the receiver (e.g., a UE) as having the same parameters, regardless of whether or not the transmitting antennas of the network node themselves are physically co-located. In NR, there are four types of quasi-co-location (QCL) relations. Specifically, a QCL relation of a given type means that certain parameters about a second reference RF signal on a second beam can be derived from information about a source reference RF signal on a source beam. Thus, if the source reference RF signal is QCL Type A, the receiver can use the source reference RF signal to estimate the Doppler shift, Doppler spread, average delay, and delay spread of a second reference RF signal transmitted on the same channel. If the source reference RF signal is QCL Type B, the receiver can use the source reference RF signal to estimate the Doppler shift and Doppler spread of a second reference RF signal transmitted on the same channel. If the source reference RF signal is QCL Type C, the receiver can use the source reference RF signal to estimate the Doppler shift and average delay of a second reference RF signal transmitted on the same channel. If the source reference RF signal is QCL Type D, the receiver can use the source reference RF signal to estimate the spatial receive parameter of a second reference RF signal transmitted on the same channel.

In receive beamforming, the receiver uses a receive beam to amplify RF signals detected on a given channel. For example, the receiver can increase the gain setting and/or adjust the phase setting of an array of antennas in a particular direction to amplify (e.g., to increase the gain level of) the RF signals received from that direction. Thus, when a receiver is said to beamform in a certain direction, it means the beam gain in that direction is high relative to the beam gain along other directions, or the beam gain in that direction is the highest compared to the beam gain in that direction of all other receive beams available to the receiver. This results in a stronger received signal strength (e.g., reference signal received power (RSRP), reference signal received quality (RSRQ), signal-to-interference-plus-noise ratio (SINR), etc.) of the RF signals received from that direction.

Transmit and receive beams may be spatially related. A spatial relation means that parameters for a second beam (e.g., a transmit or receive beam) for a second reference signal can be derived from information about a first beam (e.g., a receive beam or a transmit beam) for a first reference signal. For example, a UE may use a particular receive beam to receive a reference downlink reference signal (e.g., synchronization signal block (SSB)) from a base station. The UE can then form a transmit beam for sending an uplink reference signal (e.g., sounding reference signal (SRS)) to that base station based on the parameters of the receive beam.

Note that a “downlink” beam may be either a transmit beam or a receive beam, depending on the entity forming it. For example, if a base station is forming the downlink beam to transmit a reference signal to a UE, the downlink beam is a transmit beam. If the UE is forming the downlink beam, however, it is a receive beam to receive the downlink reference signal. Similarly, an “uplink” beam may be either a transmit beam or a receive beam, depending on the entity forming it. For example, if a base station is forming the uplink beam, it is an uplink receive beam, and if a UE is forming the uplink beam, it is an uplink transmit beam.

The electromagnetic spectrum is often subdivided, based on frequency/wavelength, into various classes, bands, channels, etc. In 5G NR two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the EHF band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

In a multi-carrier system, such as 5G, one of the carrier frequencies is referred to as the “primary carrier” or “anchor carrier” or “primary serving cell” or “PCell,” and the remaining carrier frequencies are referred to as “secondary carriers” or “secondary serving cells” or “SCells.” In carrier aggregation, the anchor carrier is the carrier operating on the primary frequency (e.g., FR1) utilized by a UE 104/182 and the cell in which the UE 104/182 either performs the initial radio resource control (RRC) connection establishment procedure or initiates the RRC connection re-establishment procedure. The primary carrier carries all common and UE-specific control channels and may be a carrier in a licensed frequency (however, this is not always the case). A secondary carrier is a carrier operating on a second frequency (e.g., FR2) that may be configured once the RRC connection is established between the UE 104 and the anchor carrier and that may be used to provide additional radio resources. In some cases, the secondary carrier may be a carrier in an unlicensed frequency. The secondary carrier may contain only necessary signaling information and signals, for example, those that are UE-specific may not be present in the secondary carrier, since both primary uplink and downlink carriers are typically UE-specific. This means that different UEs 104/182 in a cell may have different downlink primary carriers. The same is true for the uplink primary carriers. The network is able to change the primary carrier of any UE 104/182 at any time. This is done, for example, to balance the load on different carriers. Because a “serving cell” (whether a PCell or an SCell) corresponds to a carrier frequency/component carrier over which some base station is communicating, the term “cell,” “serving cell,” “component carrier,” “carrier frequency,” and the like can be used interchangeably.

For example, still referring to FIG. 1, one of the frequencies utilized by the macro cell base stations 102 may be an anchor carrier (or “PCell”) and other frequencies utilized by the macro cell base stations 102 and/or the mmW base station 180 may be secondary carriers (“SCells”). The simultaneous transmission and/or reception of multiple carriers enables the UE 104/182 to significantly increase its data transmission and/or reception rates. For example, two 20 MHz aggregated carriers in a multi-carrier system would theoretically lead to a two-fold increase in data rate (i.e., 40 MHz), compared to that attained by a single 20 MHz carrier.

In the example of FIG. 1, any of the illustrated UEs (shown in FIG. 1 as a single UE 104 for simplicity) may receive signals 124 from one or more Earth orbiting space vehicles (SVs) 112 (e.g., satellites). In an aspect, the SVs 112 may be part ofa satellite positioning system that a UE 104 can use as an independent source of location information. A satellite positioning system typically includes a system of transmitters (e.g., SVs 112) positioned to enable receivers (e.g., UEs 104) to determine their location on or above the Earth based, at least in part, on positioning signals (e.g., signals 124) received from the transmitters. Such a transmitter typically transmits a signal marked with a repeating pseudo-random noise (PN) code of a set number of chips. While typically located in SVs 112, transmitters may sometimes be located on ground-based control stations, base stations 102, and/or other UEs 104. A UE 104 may include one or more dedicated receivers specifically designed to receive signals 124 for deriving geo location information from the SVs 112.

In a satellite positioning system, the use of signals 124 can be augmented by various satellite-based augmentation systems (SBAS) that may be associated with or otherwise enabled for use with one or more global and/or regional navigation satellite systems. For example an SBAS may include an augmentation system(s) that provides integrity information, differential corrections, etc., such as the Wide Area Augmentation System (WAAS), the European Geostationary Navigation Overlay Service (EGNOS), the Multi-functional Satellite Augmentation System (MSAS), the Global Positioning System (GPS) Aided Geo Augmented Navigation or GPS and Geo Augmented Navigation system (GAGAN), and/or the like. Thus, as used herein, a satellite positioning system may include any combination of one or more global and/or regional navigation satellites associated with such one or more satellite positioning systems.

In an aspect, SVs 112 may additionally or alternatively be part of one or more non-terrestrial networks (NTNs). In an NTN, an SV 112 is connected to an earth station (also referred to as a ground station, NTN gateway, or gateway), which in turn is connected to an element in a 5G network, such as a modified base station 102 (without a terrestrial antenna) or a network node in a 5GC. This element would in turn provide access to other elements in the 5G network and ultimately to entities external to the 5G network, such as Internet web servers and other user devices. In that way, a UE 104 may receive communication signals (e.g., signals 124) from an SV 112 instead of, or in addition to, communication signals from a terrestrial base station 102.

Leveraging the increased data rates and decreased latency of NR, among other things, vehicle-to-everything (V2X) communication technologies are being implemented to support intelligent transportation systems (ITS) applications, such as wireless communications between vehicles (vehicle-to-vehicle (V2V)), between vehicles and the roadside infrastructure (vehicle-to-infrastructure (V2I)), and between vehicles and pedestrians (vehicle-to-pedestrian (V2P)). The goal is for vehicles to be able to sense the environment around them and communicate that information to other vehicles, infrastructure, and personal mobile devices. Such vehicle communication will enable safety, mobility, and environmental advancements that current technologies are unable to provide. Once fully implemented, the technology is expected to reduce unimpaired vehicle crashes by 80%.

Still referring to FIG. 1, the wireless communications system 100 may include multiple V-UEs 160 that may communicate with base stations 102 over communication links 120 using the Uu interface (i.e., the air interface between a UE and a base station). V-UEs 160 may also communicate directly with each other over a wireless sidelink 162, with a roadside unit (RSU) 164 (a roadside access point) over a wireless sidelink 166, or with sidelink-capable UEs 104 over a wireless sidelink 168 using the PC5 interface (i.e., the air interface between sidelink-capable UEs). A wireless sidelink (or just “sidelink”) is an adaptation of the core cellular (e.g., LTE, NR) standard that allows direct communication between two or more UEs without the communication needing to go through a base station. Sidelink communication may be unicast or multicast, and may be used for device-to-device (D2D) media-sharing, V2V communication, V2X communication (e.g., cellular V2X (eV2X) communication, enhanced V2X (eV2X) communication, etc.), emergency rescue applications, etc. One or more of a group of V-UEs 160 utilizing sidelink communications may be within the geographic coverage area 110 of a base station 102. Other V-UEs 160 in such a group may be outside the geographic coverage area 110 of a base station 102 or be otherwise unable to receive transmissions from a base station 102. In some cases, groups of V-UEs 160 communicating via sidelink communications may utilize a one-to-many (1:M) system in which each V-UE 160 transmits to every other V-UE 160 in the group. In some cases, a base station 102 facilitates the scheduling of resources for sidelink communications. In other cases, sidelink communications are carried out between V-UEs 160 without the involvement of a base station 102.

In an aspect, the sidelinks 162, 166, 168 may operate over a wireless communication medium of interest, which may be shared with other wireless communications between other vehicles and/or infrastructure access points, as well as other RATs. A “medium” may be composed of one or more time, frequency, and/or space communication resources (e.g., encompassing one or more channels across one or more carriers) associated with wireless communication between one or more transmitter/receiver pairs.

In an aspect, the sidelinks 162, 166, 168 may be eV2X links. A first generation of cV2X has been standardized in LTE, and the next generation is expected to be defined in NR, eV2X is a cellular technology that also enables device-to-device communications. In the U.S. and Europe, eV2X is expected to operate in the licensed ITS band in sub-6 GHz.

Other bands may be allocated in other countries. Thus, as a particular example, the medium of interest utilized by sidelinks 162, 166, 168 may correspond to at least a portion of the licensed ITS frequency band of sub-6 GHz. However, the present disclosure is not limited to this frequency band or cellular technology.

In an aspect, the sidelinks 162, 166, 168 may be dedicated short-range communications (DSRC) links. DSRC is a one-way or two-way short-range to medium-range wireless communication protocol that uses the wireless access for vehicular environments (WAVE) protocol, also known as IEEE 802.11p, for V2V, V2I, and V2P communications. IEEE 802.11p is an approved amendment to the IEEE 802.11 standard and operates in the licensed ITS band of 5.9 GHz (5.85-5.925 GHz) in the U.S. In Europe, IEEE 802.11p operates in the ITS G5A band (5.875-5.905 MHz). Other bands may be allocated in other countries. The V2V communications briefly described above occur on the Safety Channel, which in the U.S. is typically a 10 MHz channel that is dedicated to the purpose of safety. The remainder of the DSRC band (the total bandwidth is 75 MHz) is intended for other services of interest to drivers, such as road rules, tolling, parking automation, etc. Thus, as a particular example, the mediums of interest utilized by sidelinks 162, 166, 168 may correspond to at least a portion of the licensed ITS frequency band of 5.9 GHz.

Alternatively, the medium of interest may correspond to at least a portion of an unlicensed frequency band shared among various RATs. Although different licensed frequency bands have been reserved for certain communication systems (e.g., by a government entity such as the Federal Communications Commission (FCC) in the United States), these systems, in particular those employing small cell access points, have recently extended operation into unlicensed frequency bands such as the Unlicensed National Information Infrastructure (U-NII) band used by WLAN technologies, most notably IEEE 802.11x WLAN technologies generally referred to as “Wi-Fi.” Example systems of this type include different variants of CDMA systems, TDMA systems, FDMA systems, orthogonal FDMA (OFDMA) systems, single-carrier FDMA (SC-FDMA) systems, and so on.

Communications between the V-UEs 160 are referred to as V2V communications, communications between the V-UEs 160 and the one or more RSUs 164 are referred to as V2I communications, and communications between the V-UEs 160 and one or more UEs 104 (where the UEs 104 are P-UEs) are referred to as V2P communications. The V2V communications between V-UEs 160 may include, for example, information about the position, speed, acceleration, heading, and other vehicle data of the V-UEs 160. The V2I information received at a V-UE 160 from the one or more RSUs 164 may include, for example, road rules, parking automation information, etc. The V2P communications between a V-UE 160 and a UE 104 may include information about, for example, the position, speed, acceleration, and heading of the V-UE 160 and the position, speed (e.g., where the UE 104 is carried by a user on a bicycle), and heading of the UE 104.

Note that although FIG. 1 only illustrates two of the UEs as V-UEs (V-UEs 160), any of the illustrated UEs (e.g., UEs 104, 152, 182, 190) may be V-UEs. In addition, while only the V-UEs 160 and a single UE 104 have been illustrated as being connected over a sidelink, any of the UEs illustrated in FIG. 1, whether V-UEs, P-UEs, etc., may be capable of sidelink communication. Further, although only UE 182 was described as being capable of beam forming, any of the illustrated UEs, including V-UEs 160, may be capable of beam forming. Where V-UEs 160 are capable of beam forming, they may beam form towards each other (i.e., towards other V-UEs 160), towards RSUs 164, towards other UEs (e.g., UEs 104, 152, 182, 190), etc. Thus, in some cases, V-UEs 160 may utilize beamforming over sidelinks 162, 166, and 168.

The wireless communications system 100 may further include one or more UEs, such as UE 190, that connects indirectly to one or more communication networks via one or more device-to-device (D2D) peer-to-peer (P2P) links. In the example of FIG. 1, UE 190 has a D2D P2P link 192 with one of the UEs 104 connected to one of the base stations 102 (e.g., through which UE 190 may indirectly obtain cellular connectivity) and a D2D P2P link 194 with WLAN STA 152 connected to the WLAN AP 150 (through which UE 190 may indirectly obtain WLAN-based Internet connectivity). In an example, the D2D P2P links 192 and 194 may be supported with any well-known D2D RAT, such as LTE Direct (LTE-D), WiFi Direct (WiFi-D), Bluetooth®V, and so on. As another example, the D2D P2P links 192 and 194 may be sidelinks, as described above with reference to sidelinks 162, 166, and 168.

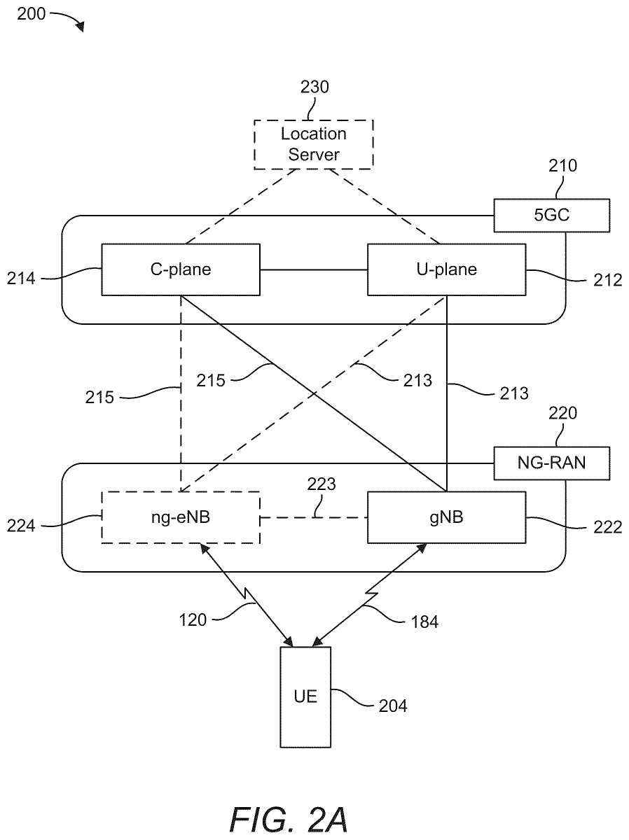

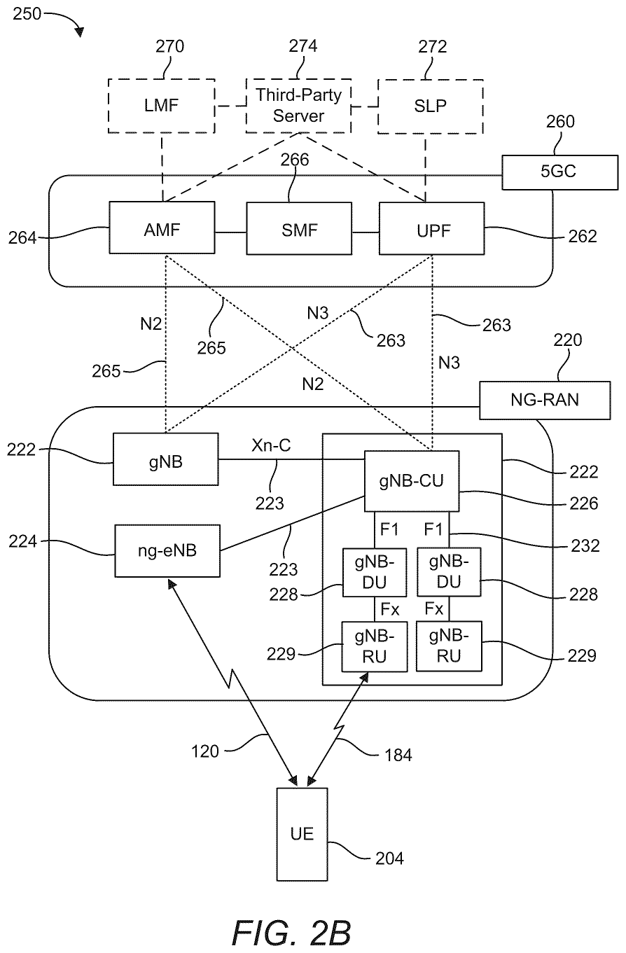

FIG. 2A illustrates an example wireless network structure 200. For example, a 5GC 210 (also referred to as a Next Generation Core (NGC)) can be viewed functionally as control plane (C-plane) functions 214 (e.g., UE registration, authentication, network access, gateway selection, etc.) and user plane (U-plane) functions 212, (e.g., UE gateway function, access to data networks, Internet protocol (IP) routing, etc.) which operate cooperatively to form the core network. User plane interface (NG-U) 213 and control plane interface (NG-C) 215 connect the gNB 222 to the 5GC 210 and specifically to the user plane functions 212 and control plane functions 214, respectively. In an additional configuration, an ng-eNB 224 may also be connected to the 5GC 210 via NG-C 215 to the control plane functions 214 and NG-U 213 to user plane functions 212. Further, ng-eNB 224 may directly communicate with gNB 222 via a backhaul connection 223. In some configurations, a Next Generation RAN (NG-RAN) 220 may have one or more gNBs 222, while other configurations include one or more of both ng-eNBs 224 and gNBs 222. Either (or both) gNB 222 or ng-eNB 224 may communicate with one or more UEs 204 (e.g., any of the UEs described herein).

Another optional aspect may include a location server 230, which may be in communication with the 5GC 210 to provide location assistance for UE(s) 204. The location server 230 can be implemented as a plurality of separate servers (e.g., physically separate servers, different software modules on a single server, different software modules spread across multiple physical servers, etc.), or alternately may each correspond to a single server. The location server 230 can be configured to support one or more location services for UEs 204 that can connect to the location server 230 via the core network, 5GC 210, and/or via the Internet (not illustrated). Further, the location server 230 may be integrated into a component of the core network, or alternatively may be external to the core network (e.g., a third party server, such as an original equipment manufacturer (OEM) server or service server).

FIG. 2B illustrates another example wireless network structure 250. A 5GC 260 (which may correspond to 5GC 210 in FIG. 2A) can be viewed functionally as control plane functions, provided by an access and mobility management function (AMF) 264, and user plane functions, provided by a user plane function (UPF) 262, which operate cooperatively to form the core network (i.e., 5GC 260). The functions of the AMF 264 include registration management, connection management, reachability management, mobility management, lawful interception, transport for session management (SM) messages between one or more UEs 204 (e.g., any of the UEs described herein) and a session management function (SMF) 266, transparent proxy services for routing SM messages, access authentication and access authorization, transport for short message service (SMS) messages between the UE 204 and the short message service function (SMSF) (not shown), and security anchor functionality (SEAF). The AMF 264 also interacts with an authentication server function (AUSF) (not shown) and the UE 204, and receives the intermediate key that was established as a result of the UE 204 authentication process. In the case of authentication based on a UMTS (universal mobile telecommunications system) subscriber identity module (USIM), the AMF 264 retrieves the security material from the AUSF. The functions of the AMF 264 also include security context management (SCM). The SCM receives a key from the SEAF that it uses to derive access-network specific keys. The functionality of the AMF 264 also includes location services management for regulatory services, transport for location services messages between the UE 204 and a LMF 270 (which acts as a location server 230), transport for location services messages between the NG-RAN 220 and the LMF 270, evolved packet system (EPS) bearer identifier allocation for interworking with the EPS, and UE 204 mobility event notification. In addition, the AMF 264 also supports functionalities for non-3GPP (Third Generation Partnership Project) access networks.

Functions of the UPF 262 include acting as an anchor point for intra-/inter-RAT mobility (when applicable), acting as an external protocol data unit (PDU) session point of interconnect to a data network (not shown), providing packet routing and forwarding, packet inspection, user plane policy rule enforcement (e.g., gating, redirection, traffic steering), lawful interception (user plane collection), traffic usage reporting, quality of service (QoS) handling for the user plane (e.g., uplink/downlink rate enforcement, reflective QoS marking in the downlink), uplink traffic verification (service data flow (SDF) to QoS flow mapping), transport level packet marking in the uplink and downlink, downlink packet buffering and downlink data notification triggering, and sending and forwarding of one or more “end markers” to the source RAN node. The UPF 262 may also support transfer of location services messages over a user plane between the UE 204 and a location server, such as an SLP 272.

The functions of the SMF 266 include session management, UE IP address allocation and management, selection and control of user plane functions, configuration of traffic steering at the UPF 262 to route traffic to the proper destination, control of part of policy enforcement and QoS, and downlink data notification. The interface over which the SMF 266 communicates with the AMF 264 is referred to as the N11 interface.

Another optional aspect may include an LMF 270, which may be in communication with the 5GC 260 to provide location assistance for UEs 204. The LMF 270 can be implemented as a plurality of separate servers (e.g., physically separate servers, different software modules on a single server, different software modules spread across multiple physical servers, etc.), or alternately may each correspond to a single server. The LMF 270 can be configured to support one or more location services for UEs 204 that can connect to the LMF 270 via the core network, 5GC 260, and/or via the Internet (not illustrated). The SLP 272 may support similar functions to the LMF 270, but whereas the LMF 270 may communicate with the AMF 264, NG-RAN 220, and UEs 204 over a control plane (e.g., using interfaces and protocols intended to convey signaling messages and not voice or data), the SLP 272 may communicate with UEs 204 and external clients (e.g., third-party server 274) over a user plane (e.g., using protocols intended to carry voice and/or data like the transmission control protocol (TCP) and/or IP).

Yet another optional aspect may include a third-party server 274, which may be in communication with the LMF 270, the SLP 272, the 5GC 260 (e.g., via the AMF 264 and/or the UPF 262), the NG-RAN 220, and/or the UE 204 to obtain location information (e.g., a location estimate) for the UE 204. As such, in some cases, the third-party server 274 may be referred to as a location services (LCS) client or an external client. The third-party server 274 can be implemented as a plurality of separate servers (e.g., physically separate servers, different software modules on a single server, different software modules spread across multiple physical servers, etc.), or alternately may each correspond to a single server.

User plane interface 263 and control plane interface 265 connect the 5GC 260, and specifically the UPF 262 and AMF 264, respectively, to one or more gNBs 222 and/or ng-eNBs 224 in the NG-RAN 220. The interface between gNB(s) 222 and/or ng-eNB(s) 224 and the AMF 264 is referred to as the “N2” interface, and the interface between gNB(s) 222 and/or ng-eNB(s) 224 and the UPF 262 is referred to as the “N3” interface. The gNB(s) 222 and/or ng-eNB(s) 224 of the NG-RAN 220 may communicate directly with each other via backhaul connections 223, referred to as the “Xn-C” interface. One or more of gNBs 222 and/or ng-eNBs 224 may communicate with one or more UEs 204 over a wireless interface, referred to as the “Uu” interface.

The functionality of a gNB 222 may be divided between a gNB central unit (gNB-CU) 226, one or more gNB distributed units (gNB-DUs) 228, and one or more gNB radio units (gNB-RUs) 229. A gNB-CU 226 is a logical node that includes the base station functions of transferring user data, mobility control, radio access network sharing, positioning, session management, and the like, except for those functions allocated exclusively to the gNB-DU(s) 228. More specifically, the gNB-CU 226 generally host the RRC, service data adaptation protocol (SDAP), and packet data convergence protocol (PDCP) protocols of the gNB 222. A gNB-DU 228 is a logical node that generally hosts the radio link control (RLC) and medium access control (MAC) layer of the gNB 222. Its operation is controlled by the gNB-CU 226. One gNB-DU 228 can support one or more cells, and one cell is supported by only one gNB-DU 228. The interface 232 between the gNB-CU 226 and the one or more gNB-DUs 228 is referred to as the “F1” interface. The physical (PHY) layer functionality of a gNB 222 is generally hosted by one or more standalone gNB-RUs 229 that perform functions such as power amplification and signal transmission/reception. The interface between a gNB-DU 228 and a gNB-RU 229 is referred to as the “Fx” interface. Thus, a UE 204 communicates with the gNB-CU 226 via the RRC, SDAP, and PDCP layers, with a gNB-DU 228 via the RLC and MAC layers, and with a gNB-RU 229 via the PHY layer.

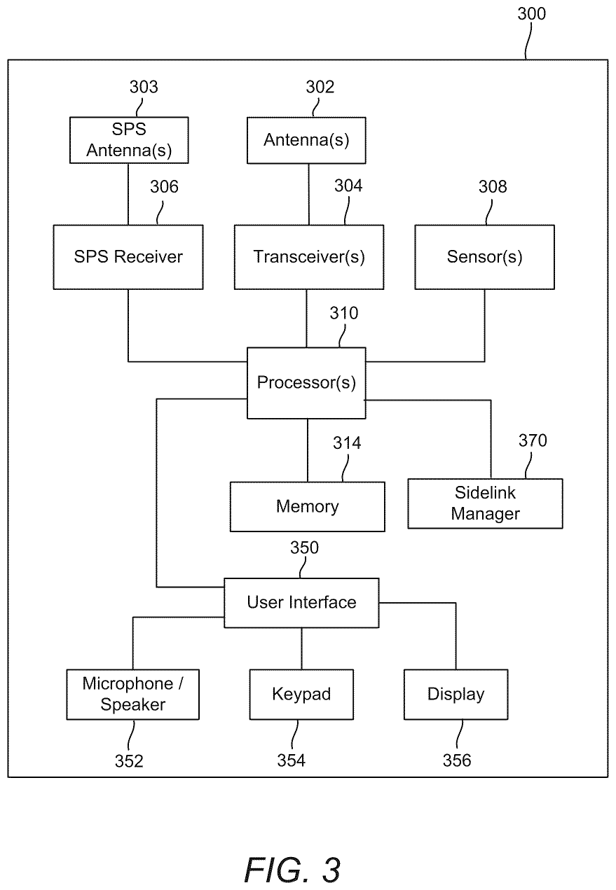

FIG. 3 is a block diagram illustrating various components of an example UE 300, according to aspects of the disclosure. In an aspect, the UE 300 may correspond to any of the UEs described herein. As a specific example, the UE 300 may be a V-UE, such as V-UE 160 in FIG. 1. For the sake of simplicity, the various features and functions illustrated in the block diagram of FIG. 3 are connected together using a common data bus that is meant to represent that these various features and functions are operatively coupled together. Those skilled in the art will recognize that other connections, mechanisms, features, functions, or the like, may be provided and adapted as necessary to operatively couple and configure an actual UE. Further, it is also recognized that one or more of the features or functions illustrated in the example of FIG. 3 may be further subdivided, or two or more of the features or functions illustrated in FIG. 3 may be combined.

The UE 300 may include one or more transceivers 304 connected to one or more antennas 302 and providing means for communicating (e.g., means for transmitting, means for receiving, means for measuring, means for tuning, means for refraining from transmitting, etc.) with other network nodes, such as V-UEs (e.g., V-UEs 160), infrastructure access points (e.g., roadside access unit 164), P-UEs (e.g., UEs 104), base stations (e.g., base stations 102), etc., via at least one designated RAT (e.g., eV2X or IEEE 802.11p) over one or more communication links (e.g., communication links 120, sidelinks 162, 166, 168, mmW communication link 184). The one or more transceivers 304 may be variously configured for transmitting and encoding signals (e.g., messages, indications, information, and so on), and, conversely, for receiving and decoding signals (e.g., messages, indications, information, pilots, and so on) in accordance with the designated RAT. In an aspect, the one or more transceivers 304 and the antenna(s) 302 may form a (wireless) communication interface of the UE 300.

As used herein, a “transceiver” may include at least one transmitter and at least one receiver in an integrated device (e.g., embodied as a transmitter circuit and a receiver circuit of a single communication device) in some implementations, may comprise a separate transmitter device and a separate receiver device in some implementations, or may be embodied in other ways in other implementations. In an aspect, a transmitter may include or be coupled to a plurality of antennas (e.g., antenna(s) 302), such as an antenna array, that permits the UE 300 to perform transmit “beamforming,” as described herein. Similarly, a receiver may include or be coupled to a plurality of antennas (e.g., antenna(s) 302), such as an antenna array, that permits the UE 300 to perform receive beamforming, as described herein. In an aspect, the transmitter(s) and receiver(s) may share the same plurality of antennas (e.g., antenna(s) 302), such that the UE 300 can only receive or transmit at a given time, not both at the same time. In some cases, a transceiver may not provide both transmit and receive functionalities. For example, a low functionality receiver circuit may be employed in some designs to reduce costs when providing full communication is not necessary (e.g., a receiver chip or similar circuitry simply providing low-level sniffing).

The UE 300 may also include a satellite positioning system (SPS) receiver 306. The SPS receiver 306 may be connected to the one or more SPS antennas 303 and may provide means for receiving and/or measuring satellite signals. The SPS receiver 306 may comprise any suitable hardware and/or software for receiving and processing SPS signals, such as GPS signals. The SPS receiver 306 requests information and operations as appropriate from the other systems, and performs the calculations necessary to determine the UE's 300 position using measurements obtained by any suitable SPS algorithm.

One or more sensors 308 may be coupled to one or more processors 310 and may provide means for sensing or detecting information related to the state and/or environment of the UE 300, such as speed, heading (e.g., compass heading), headlight status, gas mileage, etc. By way of example, the one or more sensors 308 may include a speedometer, a tachometer, an accelerometer (e.g., a microelectromechanical systems (MEMS) device), a gyroscope, a geomagnetic sensor (e.g., a compass), an altimeter (e.g., a barometric pressure altimeter), etc.

The one or more processors 310 may include one or more central processing units (CPUs), microprocessors, microcontrollers, ASICs, processing cores, digital signal processors (DSPs), field-programmable gate arrays (FPGAs), or the like that provide processing functions, as well as other calculation and control functionality. The one or more processors 310 may therefore provide means for processing, such as means for determining, means for calculating, means for receiving, means for transmitting, means for indicating, etc. The one or more processors 310 may include any form of logic suitable for performing, or causing the components of the UE 300 to perform, at least the techniques described herein.

The one or more processors 310 may also be coupled to a memory 314 providing means for storing (including means for retrieving, means for maintaining, etc.) data and software instructions for executing programmed functionality within the UE 300. The memory 314 may be on-board the one or more processors 310 (e.g., within the same integrated circuit (IC) package), and/or the memory 314 may be external to the one or more processors 310 and functionally coupled over a data bus.

The UE 300 may include a user interface 350 that provides any suitable interface systems, such as a microphone/speaker 352, keypad 354, and display 356 that allow user interaction with the UE 300. The microphone/speaker 352 may provide for voice communication services with the UE 300. The keypad 354 may comprise any suitable buttons for user input to the UE 300. The display 356 may comprise any suitable display, such as, for example, a backlit liquid crystal display (LCD), and may further include a touch screen display for additional user input modes. The user interface 350 may therefore be a means for providing indications (e.g., audible and/or visual indications) to a user and/or for receiving user input (e.g., via user actuation of a sensing device such a keypad, a touch screen, a microphone, and so on).

In an aspect, the UE 300 may include a sidelink manager 370 coupled to the one or more processors 310. The sidelink manager 370 may be a hardware, software, or firmware component that, when executed, causes the UE 300 to perform the operations described herein. For example, the sidelink manager 370 may be a software module stored in memory 314 and executable by the one or more processors 310. As another example, the sidelink manager 370 may be a hardware circuit (e.g., an ASIC, a FPGA, etc.) within the UE 300.

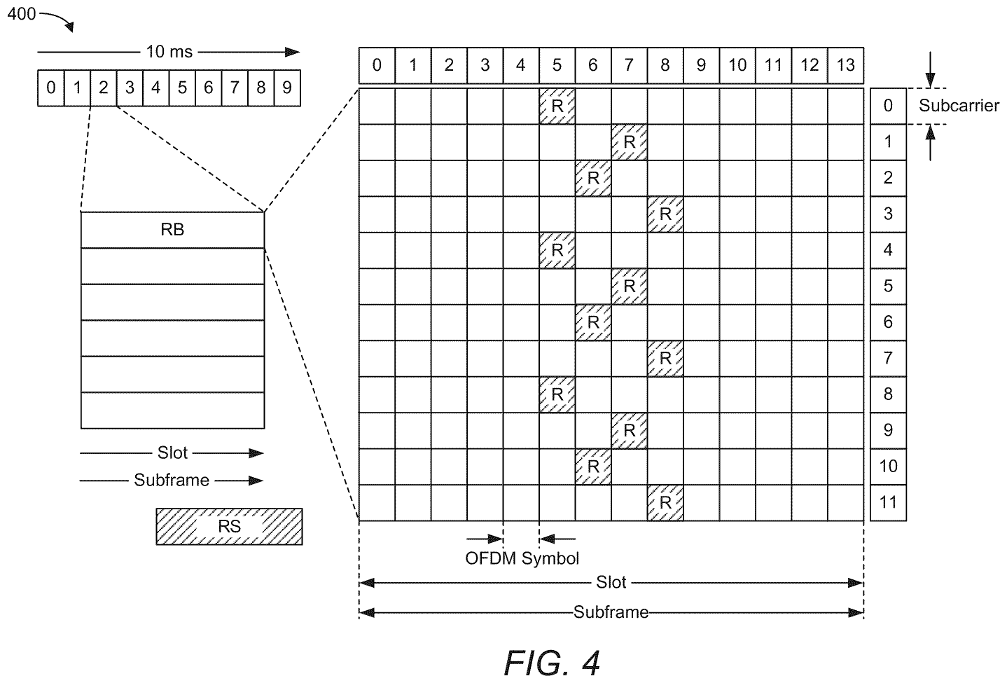

Various frame structures may be used to support downlink and uplink transmissions between network nodes (e.g., base stations and UEs). FIG. 4 is a diagram 400 illustrating an example frame structure, according to aspects of the disclosure. The frame structure may be a downlink or uplink frame structure. Such frame structures are also used in sidelink communications between UEs. Other wireless communications technologies may have different frame structures and/or different channels.

LTE, and in some cases NR, utilizes orthogonal frequency-division multiplexing (OFDM) on the downlink and single-carrier frequency division multiplexing (SC-FDM) on the uplink. Unlike LTE, however, NR has an option to use OFDM on the uplink as well. OFDM and SC-FDM partition the system bandwidth into multiple (K) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, the spacing of the subcarriers may be 15 kilohertz (kHz) and the minimum resource allocation (resource block) may be 12 subcarriers (or 180 kHz). Consequently, the nominal Fast Fourier Transform (FFT) size may be equal to 128, 256, 512, 1024, or 2048 for system bandwidth of 1.25, 2.5, 5, 10, or 20 megahertz (MHz), respectively. The system bandwidth may also be partitioned into subbands. For example, a subband may cover 1.08 MHz (i.e., 6 resource blocks), and there may be 1, 2, 4, 8, or 16 subbands for system bandwidth of 1.25, 2.5, 5, 10, or 20 MHz, respectively.

LTE supports a single numerology (subcarrier spacing (SCS), symbol length, etc.). In contrast, NR may support multiple numerologies (p), for example, subcarrier spacings of 15 kHz (μ=0), 30 kHz (μ=1), 60 kHz (μ=2), 120 kHz (μ=3), and 240 kHz (μ=4) or greater may be available. In each subcarrier spacing, there are 14 symbols per slot. For 15 kHz SCS (μ=0), there is one slot per subframe, 10 slots per frame, the slot duration is 1 millisecond (ms), the symbol duration is 66.7 microseconds (μs), and the maximum nominal system bandwidth (in MHz) with a 4K FFT size is 50. For 30 kHz SCS (μ=1), there are two slots per subframe, 20 slots per frame, the slot duration is 0.5 ms, the symbol duration is 33.3 μs, and the maximum nominal system bandwidth (in MHz) with a 4K FFT size is 100. For 60 kHz SCS (μ=2), there are four slots per subframc, 40 slots per frame, the slot duration is 0.25 ms, the symbol duration is 16.7 μs, and the maximum nominal system bandwidth (in MHz) with a 4K FFT size is 200. For 120 kHz SCS (μ=3), there are eight slots per subframe, 80 slots per frame, the slot duration is 0.125 ms, the symbol duration is 8.33 μs, and the maximum nominal system bandwidth (in MHz) with a 4K FFT size is 400. For 240 kHz SCS (μ=4), there arm 16 slots per subframe, 160 slots per frame, the slot duration is 0.0625 ms, the symbol duration is 4.17 μs, and the maximum nominal system bandwidth (in MHz) with a 4K FFT size is 800.

In the example of FIG. 4, a numerology of 15 kHz is used. Thus, in the time domain, a 10 ms frame is divided into 10 equally sized subframes of 1 ms each, and each subframe includes one time slot. In FIG. 4, time is represented horizontally (on the X axis) with time increasing from left to right, while frequency is represented vertically (on the Y axis) with frequency increasing (or decreasing) from bottom to top.

A resource grid may be used to represent time slots, each time slot including one or more time-concurrent resource blocks (RBs) (also referred to as physical RBs (PRBs)) in the frequency domain. The resource grid is further divided into multiple resource elements (REs). An RE may correspond to one symbol length in the time domain and one subcarrier in the frequency domain. In the numerology of FIG. 4, for a normal cyclic prefix, an RB may contain 12 consecutive subcarriers in the frequency domain and seven consecutive symbols in the time domain, for a total of 84 REs. For an extended cyclic prefix, an RB may contain 12 consecutive subcarriers in the frequency domain and six consecutive symbols in the time domain, for a total of 72 REs. The number of bits carried by each RE depends on the modulation scheme.

Some of the REs may carry reference (pilot) signals (RS). The reference signals may include positioning reference signals (PRS), tracking reference signals (TRS), phase tracking reference signals (PTRS), cell-specific reference signals (CRS), channel state information reference signals (CSI-RS), demodulation reference signals (DMRS), primary synchronization signals (PSS), secondary synchronization signals (SSS), synchronization signal blocks (SSBs), sounding reference signals (SRS), etc., depending on whether the illustrated frame structure is used for uplink or downlink communication. FIG. 4 illustrates example locations of REs carrying a reference signal (labeled “R”).

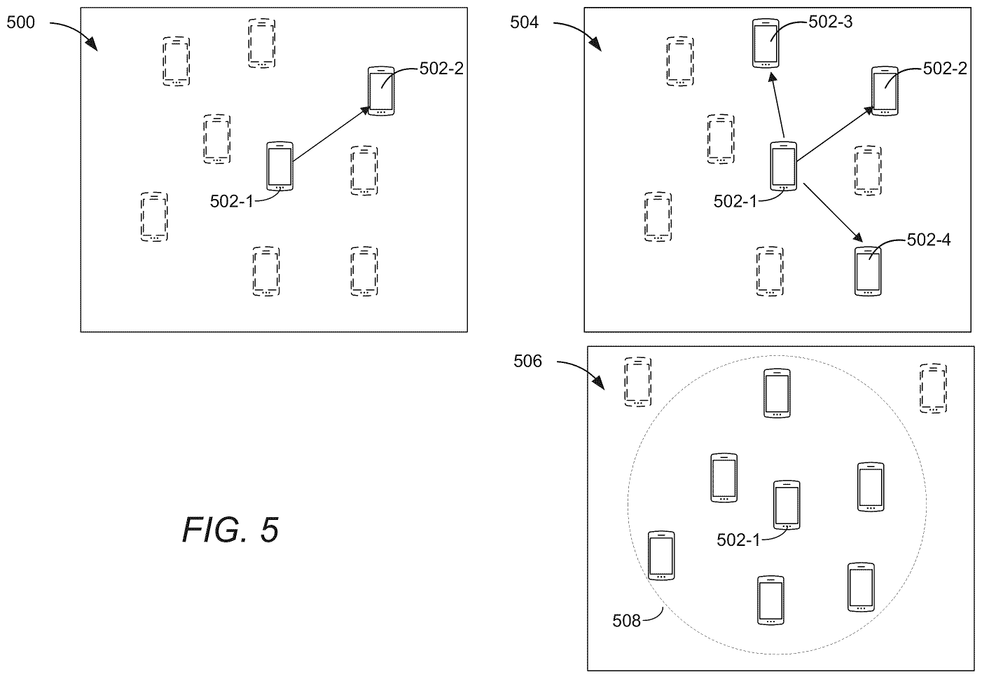

NR sidelink supports three basic transmission scenarios 1) unicast, in which case the sidelink transmission targets a specific receiving device, 2) groupcast, in which case the sidelink transmission targets a specific group of receiving devices, and 3) broadcast, in which case the sidelink transmission targets any device that is within the range of the transmission. FIG. 5 illustrates basic transmission scenarios in accordance with certain aspects of the disclosure. Transmission scenario 500 shows a unicast scenario in which UE 502-1 has targeted UE 502-2 for communication to the exclusion of other UEs in the environment. Transmission scenario 504 shows a group cast a scenario in which UE 502-1 has targeted UE 502-2, UE 502-3, and UE 502-4 for targeted communications. Transmission scenario 506 shows a broadcast scenario in which all UEs within the transmission range 508 of UE 502-1 are targeted for transmission.

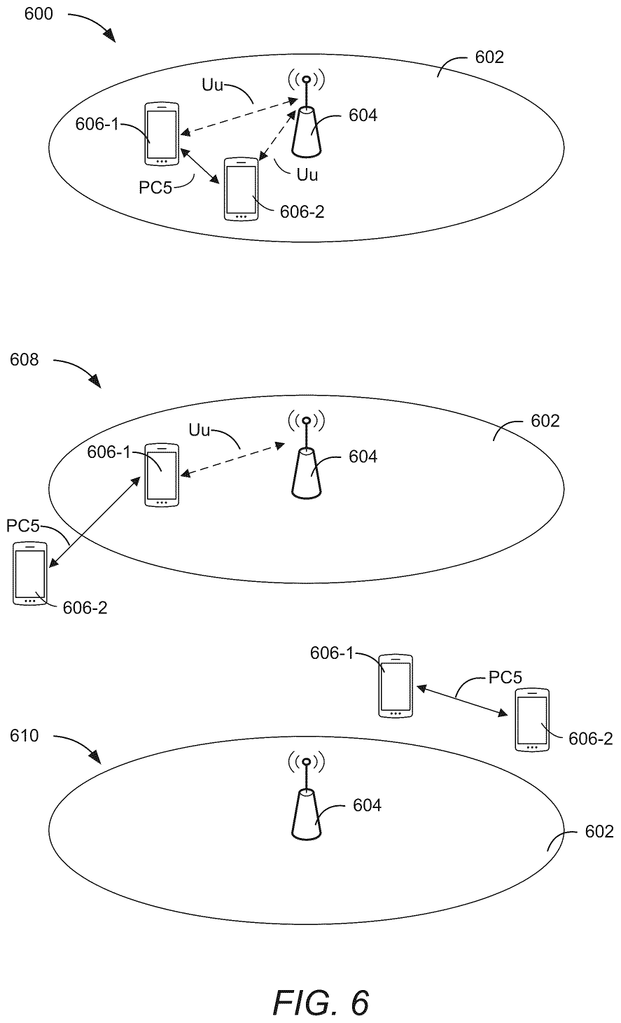

Generally, there are three deployment scenarios for NR sidelink communication in terms of the relation between the sidelink communication and an overlaid cellular network. FIG. 6 shows three such deployment scenarios in accordance with certain aspects of the disclosure. Deployment scenario 600 shows an in-coverage scenario in which both UE 606-1 and UE 606-2 are within the coverage 602 of a base station 604 and communicate with the base station 604 via Uu links. In deployment scenario 600, the UEs 606-1 and 606-2 communicate with one another via a PC5 link. To a smaller or larger extent, depending on the exact mode-of-operation of the UEs 606-1 and 606-2, the base station 604 may control the sidelink communications. Deployment scenario 608 shows a partial coverage scenario in which UE 606-1 is within coverage 602 and communicates with the base station 604 over a Uu link. In deployment scenario 608, the UEs 606-1 and 606-2 are within the communication range of one another and communicate via a PC5 link. In an aspect, UE 606-1 may act as a relay for communications between base station 604 and UE 606-2. Deployment scenario 610 shows out-of-coverage operation in which neither UE 606-1 nor UE 606-2 are within coverage 602 but are nevertheless within communication range of one another over a PC5 link.

Similar to downlink and uplink transmissions that take place over a Uu link, sidelink transmissions take place over a set of physical channels on to which a transport channel is mapped and/or which carry different types of L1/L2 control signaling. The physical channels include 1) a physical sidelink shared channel (PSSCH), 2) a physical sidelink control channel (PSCCH), 3) a physical sidelink broadcast channel (PSBCH), and 4) the physical sidelink feedback channel (PSFCH). The PSCCH carries control information in the sidelink. The PSSCH carries data payload in the sidelink and additional control information. The PSBCH carries information for supporting synchronization in the sidelink. PSBCH is sent within a sidelink synchronization signal block (S-SSB). The PSFCH carries feedback related to the successful or failed reception of a sidelink transmission.

Furthermore, NR sidelink communications support various signals, including reference signals, that are carried in or associated with the physical channels. In this regard, a DMRS is used by a sidelink receiver for decoding the associated sidelink physical channel, i.e., PSCCH, PSSCH, PSBCH. The DMRS is sent within the associated sidelink physical channel. A sidelink primary synchronization signal (S-PSS) and sidelink secondary synchronization signal (S-SSS) may be used by a sidelink receiver to synchronize to the transmitter of these signals. S-PSS and S-SSS are sent within the S-SSB. Sidelink Channel state information reference signals (SL CSI-RS) ar used for measuring channel state information (CSI) at the receiver that is then fed back to the transmitter. The transmitter adjusts its transmission based on the fed-back CSI. SL CSI-RS is sent within the PSSCH region of the slot. Sidelink Phase-tracking reference signals (SL PT-RS) are used for mitigating the effect of phase noise (in particular at higher frequencies) resulting from imperfections of the oscillator. SL PT-RS is sent within the PSSCH region of the slot. Sidelink positioning reference signals (S-PRS) are used to conduct positioning operations to determine the absolute position of a sidelink device and/or the relative position of a sidelink device with respect to other sidelink devices. The S-PRS is sent within the PSSCH region of the slot.

In NR, only certain time and frequency resources are (pre-)configured to accommodate SL transmissions. The subset of the available SL resources is (pre-)configured to be used by several UEs for their SL transmissions. This subset of available SL resources is referred to as a resource pool.

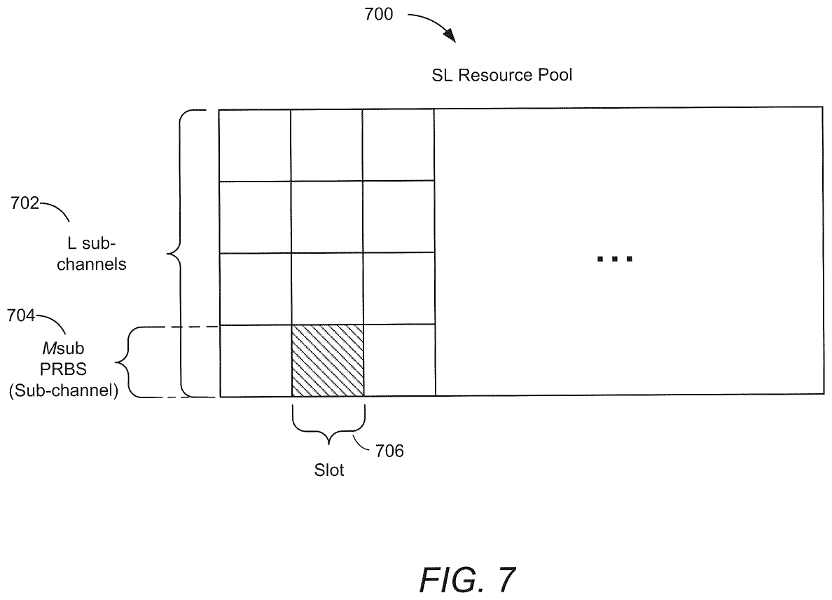

FIG. 7 shows an example resource pool 700 in accordance with certain aspects of the disclosure. A resource pool consists of contiguous PRBs and contiguous or non-contiguous slots that have been (pre-)configured for SL transmissions. In the frequency domain, a resource pool is divided into a (pre-)configured number L of contiguous sub-channels 702, where a sub-channel 704 consists of a group of consecutive PRBs in a slot 706. The number Msub of PRBs in a sub-channel corresponds to the sub-channel size, which is (pre-)configured within the resource pool 700. In an aspect, the sub-channel size Msub can be equal to 10, 12, 15, 20, 25, 50, 75, or 100 PRBs. A sub-channel represents the smallest frequency domain unit for a sidelink data transmission or reception. A sidelink transmission can use one or multiple sub-channels. In the time domain, the slots that are part of a resource pool are (pre-)configured and occur on a periodic basis. In the example of FIG. 7, sidelink resources are shown as individual resource pool elements, where each resource element consists of a single slot 706 over a sub-channel 704 comprised of a set of common physical resource blocks (PRBS).

In an aspect, the slot 706 of a sub-channel only allocates a subset of its consecutive symbols (pre-)configured for sidelink communications. The subset of SL symbols per slot is indicated with a starting symbol and a number of consecutive symbols, where these two parameters are (pre-)configured per the resource pool. The number of consecutive SL symbols can vary between 7 and 14 symbols depending on the physical channels which are carried within a slot.

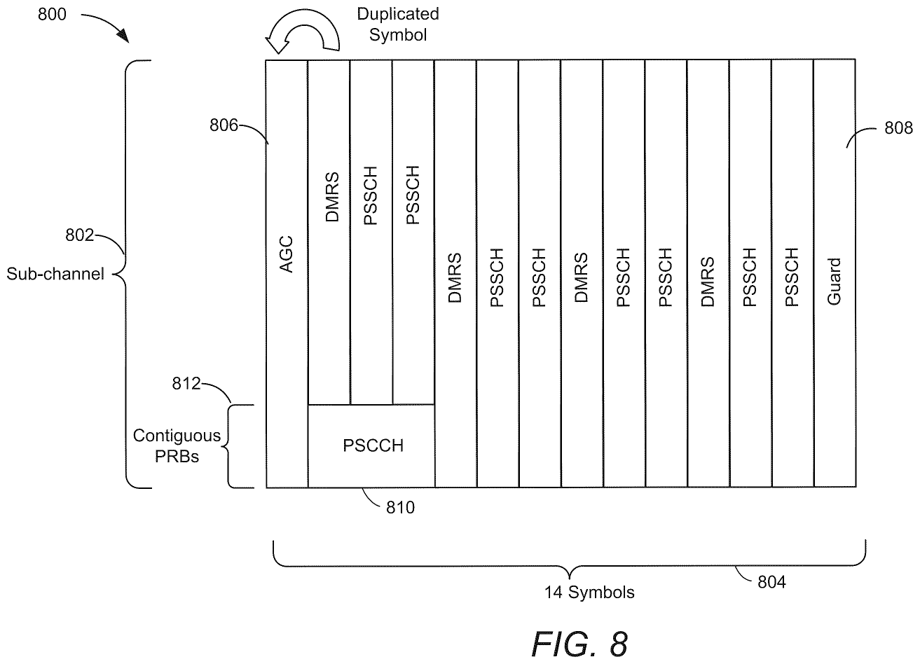

FIG. 8 depicts an example configuration of symbols of a SL resource 800 for a slot of a sub-channel in accordance with certain aspects of the disclosure. In this example, the configuration is directed to a single sub-channel 802 and a single slot 804. Here, slot 804 comprises 14 symbols including 3 PSCCH symbols and 12 PSSCH symbols. The example slot 804 includes 4 DMRS symbols which are carried in the PSSCH symbols. Among other data, the PSSCH carries the 1^{st}-stage sidelink control information (SCI) as discussed in further detail herein. The first symbol carried by each PRB of the SL resource 800 is an automatic gain control (AGC) symbol 806, which is used by the sidelink device for automatic gain control operations. In an aspect, the AGC symbol 806 may be a duplicate of the second symbol carried by each PRB of the sub-channel in 802. The last symbol carried by each PRB of the SL resource 800 is a guard symbol 808, which does not carry any sidelink data. The SL resource 800 includes a configurable number of contiguous PRBs and symbols for carrying the PSSCH 810. In this example, the PSSCH 810 is carried in the second, third, and fourth symbols of a plurality of contiguous PRBs 812.

With reference again to FIG. 8, the SL resource 800 can be shared by several UEs for their SL transmissions. The SL resources of the SL resource 800 can be used for all transmission types (i.e., unicast, groupcast, and broadcast). A UE can be (pre-) configured with multiple resource pools for transmission (e.g., transmit resource pools (RPs)) and with multiple resource pools for reception (e.g., receive resource RPs). A UE can receive data on resource pools used for SL transmissions by other UEs and transmit on the SL using its transmit RPs. In certain aspects, exceptional transmit RPs are configured for the UEs for situations that include when a UE is in a transition from idle to connected mode, when a UE experiences a link failure or a handover, or when a UE is changing between different configured transmit RPs. The use of exceptional transmit RPs in such situations aids in improving service continuity.

NR defines two resource allocation modes for sidelink communications, one centralized (Mode 1) and one distributed (Mode 2). In Mode 1, the base station (e.g., gNB) schedules sidelink resources to be used by the UE for sidelink transmissions. However, in Mode 2, the UE autonomously determines which sidelink resources of a resource pool the UE will use for transmissions.

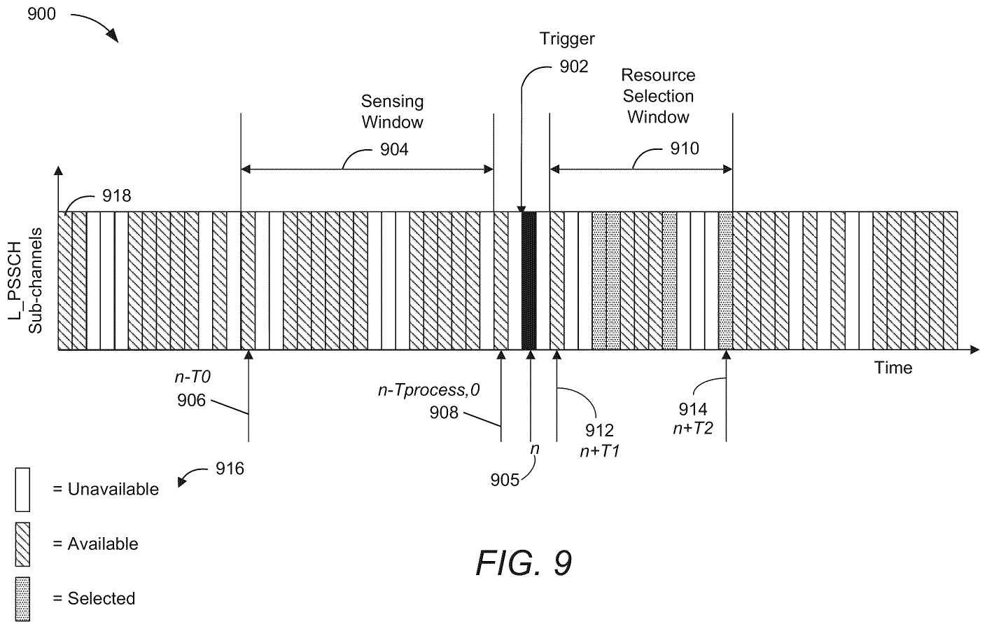

FIG. 9 is a timing diagram 900 showing an example of how SL resources may be allocated in accordance with certain aspects of the disclosure. In Mode 2, the UEs autonomously select their SL resources from a resource pool and can operate without network coverage, such as shown in the example scenario 610 of FIG. 6. The resource pool used by the UEs can be (pre-)configured by a gNB or eNB when the UE is in network coverage or pre-configured as part of the UE design.

Mode 2 uses sensing-based semi-persistent scheduling SPS for periodic traffic. The sensing procedure takes advantage of the periodic and predictable nature of basic sidelink service messages. In sensing-based SPS, the UEs reserve sub-channels in the frequency domain for a random number of consecutive periodic transmissions in the time domain. The number of slots for transmission and retransmissions within each periodic resource reservation period depends on the resource selection procedure. The number of reserved sub-channels per slot depends on the size of data to be transmitted.

The sensing-based resource selection procedure is composed of two stages: 1) a sensing procedure and 2) a resource selection procedure. In the example shown in FIG. 9, the procedures are executed in response to a trigger event 902. The trigger event 902 may coincide with a number of different event types. In certain aspects, the trigger event 902 may occur on a configurable periodic basis. In certain aspects, the trigger event 902 occurs when a particular task is executed by the UE, such as a positioning operation executed by the UE. A UE can also select new SL resources in response to a re-evaluation or pre-emption condition. For purposes of the following discussion, the resource allocation process originates at slot n 905, shown here as the first slot after the trigger event 902.

The sensing procedure is in charge of identifying the resources which are candidates for resource selection and is based on the decoding of the 1st-stage-SCI received from the surrounding UEs and on sidelink power measurements in terms of RSRP. The sensing procedure is performed during a sensing window 904, which is defined by a pre-configured parameter TO and a specific parameter Tproc,0. The specific parameter Tproc,0 accounts for the time required by the UE to complete decoding the SCIs from other UEs and perform measurements on DMRS of signals transmitted on resources of the other UEs. As shown in FIG. 9, with respect to slot n 905, the UE will consider the sidelink RSRP measurements performed during the interval n−T0 906 to n−Tproc,0 908.

Sidelink RSRP measurements can be computed using the power spectral density of the signal received in the PSCCH or in the PSSCH, for which the UE has successfully decoded the 1st-stage-SCI. PSCCH RSRP and PSSCH RSRP are determined as the linear average over the power contributions (in Watts) of the resource elements that carry the DMRS associated with PSCCH and PSSCH, respectively.

Based on the information extracted from the sensing operations, the resource selection procedure determines the resource(s) that the UE may use sidelink transmissions. For that purpose, another interval known as the resource selection window 910 is defined. The resource selection window 910 is defined by the interval n+T1 912 and n+T2 914, where T1 and T2 are two parameters that are determined by the UE implementation. In certain aspects, the value of T2 depends on a packet delay budget (PDB) and on an RRC pre-configured parameter called T2,min. In the case that PDB≥T2,min, T2 is determined by the UE implementation and must meet the following condition: T2,min≤T2≤PDB. In the case that PDB≤T2, min, then T2=PDB. T is selected so that Tproc,1≤T1, where Tproc,1 is the time required to identify the candidate resources and reserve a subset of resources for sidelink transmission.

The resource selection procedure is composed of two steps. First, the candidate resources within the resource selection window 910 are identified. A resource is indicated as anon-candidate if an SCI is received on that slot or the corresponding slot is reserved by a previous SCI, and the associated sidelink RSRP measurement is above a sidelink RSRP threshold. The resulting set of candidate resources within the resource selection window 910 should be at least X % of the total resources within the resource selection window 910 to proceed with the second step of the resource selection process. The value of X is configured by RRC and, in certain aspects, can be 20%, 35% or 50%. If this condition is not met, the RSRP threshold may be increased by a predetermined amount, such as 3 dB, and the procedure is repeated. Second, the transmitting UE performs the resource selection from the identified candidate resources by reserving the selected resources in its SCI transmission. To exclude resources from the candidate pool based on sidelink measurements in previous slots, the resource reservation period (which is transmitted by the UEs in the 1st-stage-SCI) is introduced. As only the periodicity of transmissions can be extracted from the SCI, the UE that performs the resource selection uses this periodicity (if included in the decoded SCI) and assumes that the UE(s) that transmitted the SCI will do periodic transmissions with such a periodicity, during Q periods. This allows to identify and exclude the non-candidate resources of the resource selection window 910. In accordance with certain aspects of the disclosure,

$$Q = [ \frac{Tscal}{Prsvp} ] ,$$

where Prsvp refers to the resource reservation period decoded from the SCI, and Tscal corresponds to 12 converted to units of milliseconds(ms).

A sidelink resource, such as sidelink resource 918, is defined by one slot in time and L_{PSSCH} rsscu contiguous sub-channels in frequency. L_{PSSCH} is an integer in the range 1≤L_{PSSCH}≤max(L_{PSSCH}), where max(L_{PSSCH}) is the total number of sub-channels per slot in the resource selection window 910. However, in certain aspects, the value of max(L_{PSSCH}) can be modified by a congestion control process.

In the example resource allocation process of FIG. 9, T0=20 slots, Tproc,0=2 slots, T1=2 slots, and T2=16 slots. Once the resource selection is triggered at slot n, based on the measurements in the sensing window 904, the UE reserves sidelink resources within the resource selection window 910 for its own transmissions. Visual indicia corresponding to whether a sidelink resource is available, unavailable, or selected (e.g., reserved) in the example are shown in legend 916.

In accordance with certain aspects of the disclosure, the UE may reserve sidelink resources for itself as well as for other UEs. In certain aspects, the UE transmits one or more signals to other UEs indicating that the UE has reserved specific resources on behalf of the other UEs. In an aspect, other UEs would also monitor the resource pool for the PSCCH sent by the UE for the reservation. In accordance with certain aspects of the disclosure, the UE may reserve sidelink resources for transmitting its own sidelink PRS (SL-PRS) and request that other UEs transmit SL-PRS using the sidelink resources reserved by the UE on behalf of the other UEs. In such instances, the UE effectively schedules the SL-PRS resources that are to be used in positioning operations.

NR supports a number of positioning technologies, including downlink-based, uplink-based, and downlink-and-uplink-based positioning methods. Downlink-and-uplink-based positioning methods include enhanced cell-ID (E-CID) positioning and multi-round-trip-time (RTT) positioning (also referred to as “multi-cell RT”). In an RTT procedure, a first entity (e.g., a base station or a UE) transmits a first RTT-related signal (e.g., a PRS or SRS) to a second entity (e.g., a UE or base station), which transmits a second RTT-related signal (e.g., an SRS or PRS) back to the first entity. Each entity measures the time difference between the time of arrival (ToA) of the received RTT-related signal and the transmission time of the transmitted RTT-related signal. This time difference is referred to as a reception-to-transmission (Rx-Tx) time difference. The Rx-Tx time difference measurement may be made, or may be adjusted, to include only a time difference between nearest slot boundaries for the received and transmitted signals. Both entities may then send their Rx-Tx time difference measurement to a location server (e.g., an LMF 270), which calculates the round trip propagation time (i.e., RTT) between the two entities from the two Rx-Tx time difference measurements (e.g., as the sum of the two Rx-Tx time difference measurements). Alternatively, one entity may send its Rx-Tx time difference measurement to the other entity, which then calculates the RTT. The distance between the two entities can be determined from the RTT and the known signal speed (e.g., the speed of light). For multi-cell-RTT positioning, a first entity (e.g., a UE or base station) performs an RTT positioning procedure with multiple second entities (e.g., multiple base stations or UEs) to enable the location of the first entity to be determined (e.g., using multilateration) based on distances to, and the known locations of, the second entities. RTT and multi-cell-RTT methods can be combined with other positioning techniques, such as UL-AoA and DL-AoD, to improve location accuracy.

The foregoing positioning techniques may be extended to sidelink positioning in which sidelink devices (e.g., anchor UEs, target UEs, RSUs, etc.) transmit SL-PRS and measure SL-PRS from other sidelink devices. Sidelink positioning facilitates flexible deployment of sidelink devices in indoor environments (e.g., shopping malls, manufacturing plants, etc.) as well as certain outdoor environments (e.g., urban environments having a substantial number of RF obstructions) where Global Navigation Satellite System (GNSS) positioning may be difficult. Sidelink positioning may be used in any of the scenarios shown in FIG. 6. This includes sidelink positioning when the sidelink devices are operating independently of network coverage. Such independent sidelink positioning provides an opportunity for lower latency positioning operations since a UE need not establish a network connection before executing such positioning operations. Sidelink positioning also offers an opportunity for simpler relative positioning between UEs since direct ranging between two or more UEs may be conducted without a need for prior calculation of the absolute positions of the UEs. Such relative positioning may be used in public safety scenarios (e.g., firefighters tracking each other), vehicle applications (e.g., platooning, collision avoidance, etc.), unmanned aerial vehicle (UAV) applications (e.g., docking station operations), AR applications (e.g., multiple users interacting with each other in an AR application), smart home entertainment applications (e.g., contents from smartphone played on a particular TV based on the distance between the smartphone and other TVs in a range of the smartphone), etc.

Certain aspects of the disclosure include the use of sidelink resources that are dedicated to the transmission of SL-PRS by sidelink devices. In an aspect, dedicated SL-PRS resources may be used for positioning when higher timing resolution is desired. To this end, certain aspects of the disclosure include the use of standalone SL-PRS resources occupying the full bandwidth of a resource pool for positioning (RP-P). Such SL-PRS resources are considered to be “standalone” resources since the resources are not embedded into a PSSCH transmission. For the same time resources, the comb-based pattern in the frequency domain can enable different SL-PRS resources that are frequency division multiplexed (FDM'ed) in a manner similar to the PRS used for positioning in Uu connections.

Sidelink positioning, however, may introduce its own set of issues. Synchronization and clock drift are two such issues associated with time-based sidelink positioning. Synchronization can be more difficult for anchor UEs than cases in which a base station (e.g., gNBs) are used as anchors devices. As noted, GNSS timing services may be unavailable or inaccurate in certain environments. Further, different anchor UEs can have different synchronization sources (GNSS/gNB/other UEs). Clock drift can have a higher impact in sidelink positioning since SL-PRS may require longer measurement durations due to sparse availability of SL-PRS resources and corresponding SL slots in the time domain when compared with positioning using UUDL resources of a base station. As an example, using resource allocation Mode 2 and sidelink positioning, the sensing window from which sidelink resources for SL-PRS are selected may have a duration of 100 ms or as high as 1100 ms.

The sparsity of measurements is further complicated by sidelink discontinuous reception (SL-DRX) operations, where UEs are deactivated for certain periods of time to save power and other resources. As an example, SL-DRX operations may have a 160 ms periodicity. In such instances, a UE having the maximum allowed ±0.1 parts-per-million (ppm) clock drift (e.g., based on certain 3GPP standards) experiences a drift of 16 nanoseconds (nsec), which corresponds to 4.8 meters ranging error.

Certain aspects of the disclosure are directed to techniques for reducing the impact of errors introduced by synchronization and clock drift issues. To this end, certain aspects of the disclosure employ a standalone sidelink resource pool for positioning having multiple positioning resource windows, where each window is respectfully associated with one or more contiguous positioning resources. In certain aspects, the positioning resources of certain spaced apart positioning resource windows are paired with one another for reservation by a sidelink device for transmission of its own SL-PRS, while other positioning resources of one or more other positioning resource windows are reserved by the sidelink device for transmission of SL-PRS by other sidelink devices. In certain aspects, the positioning resources of the paired positioning resource windows are spaced from one another by another resource window having positioning resources that the sidelink device may reserve for transmission of SL-PRS by one or more additional sidelink devices. In certain aspects, the disclosed standalone sidelink resource pool facilitates the allocation of positioning resources in a manner that compensates for clock drift and synchronization errors occurring in two-phase synchronous, semi-synchronous, and asynchronous positioning operations. To this end, certain aspects of the disclosure allow a sidelink device to more readily reserve positioning resources for transmission of SL-PRS that are spaced from one another by time intervals meeting certain thresholds that reduce the impact of clock drift errors.

As noted, the accuracies of positioning measurements made by UEs in Mode 2 are related to the clock drift of the clocks used by the UEs in making their measurements. Such errors occur in both single-phase positioning operations (e.g., positioning operations in which only two sidelink devices are used in determining the relative position of the two sidelink devices) and two-phase positioning operations (e.g., where multiple sidelink devices transmit and/or measure multiple instances of SL-PRS on multiple positioning resources at different times to determine the relative position of the multiple sidelink devices). Further, such errors occur with respect to the application of asymmetric and semi-symmetric positioning algorithms (e.g., where the SL-PRS instances transmitted by the sidelink devices participating in the positioning operation are assumed to be spaced from one another by substantially equal time intervals meeting a threshold time interval) as well as asymmetric positioning algorithms (e.g., where the SL-PRS instances transmitted by the sidelink devices participating in the positioning operation are assumed to be spaced from one another by substantially different time intervals).

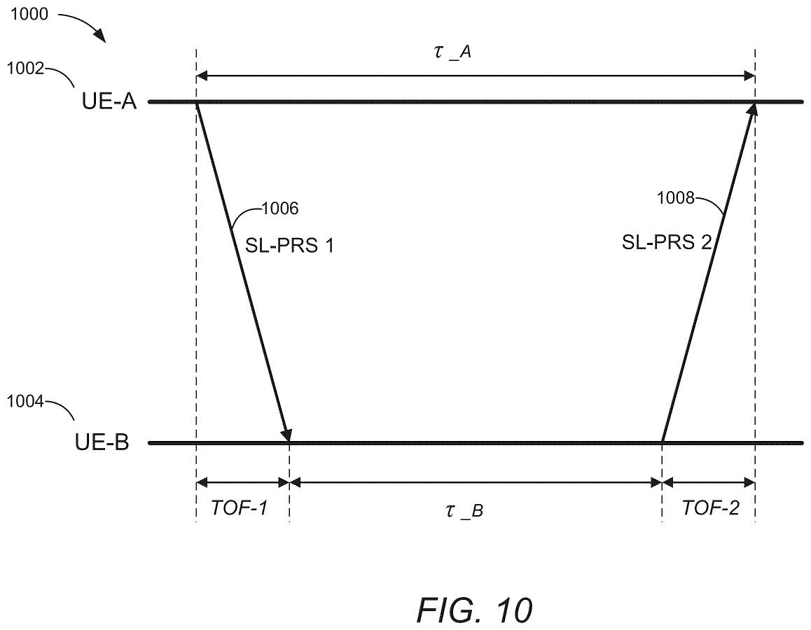

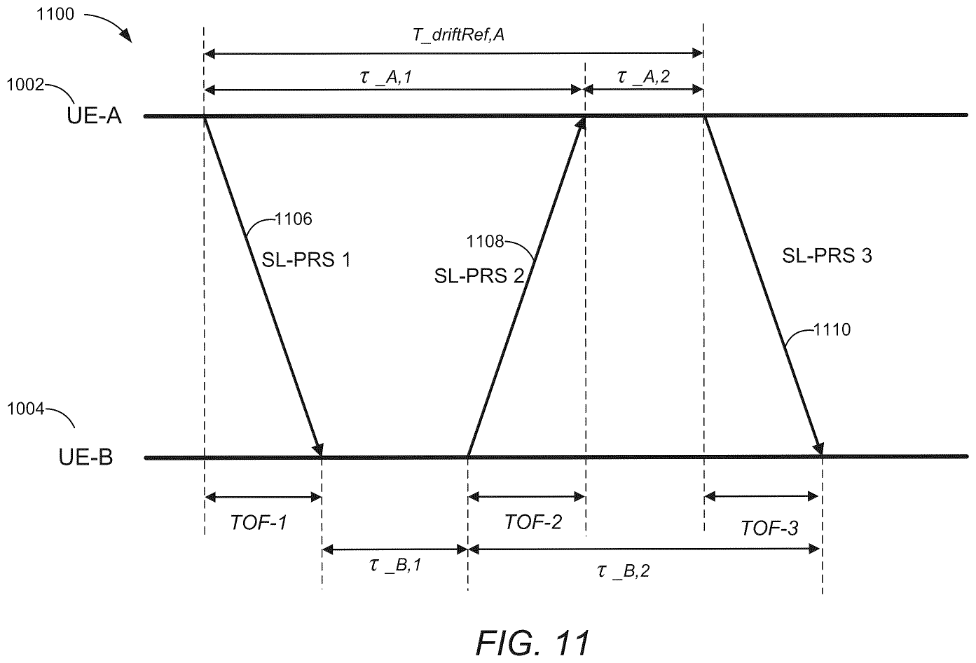

FIG. 10 depicts positioning operations executed in a single-phase positioning operation to provide a basic understanding of how clock drift may be modeled in accordance with certain aspects of the disclosure. FIGS. 11-14 illustrate how this understanding of clock drift modeling may be extended to two-phase synchronous/semi-synchronous positioning algorithms and two-phase asynchronous positioning algorithms in accordance with certain aspects of the disclosure.

FIG. 10 illustrates signals exchanged during a single-phase RTT positioning procedure 1000 between two sidelink UEs in accordance with certain aspects of the disclosure. A description of the impact of clock drift on positioning measurements can be understood with respect to the example shown in FIG. 10. In this example, the positioning operations take place between UE-A 1002 and UE-B 1004, where UE-A 1002 transmits SL-PRS 1 1006, which is received by UE-B 1004 after a first time-of-flight duration TOF-1. After a time duration τ_{B} as measured by the UE-B's clock, UE-B 1004 transmits SL-PRS 2 1008, which is received by UE-A 1002 after a second time-of-flight TOF-2. In this example, the interval between the time at which UE-A 1002 transmits SL-PRS 1 1006 and the time at which it receives SL-PRS 2 1008 from UE-B 1004 as τ_{A} measured by UE-A's clock. Throughout the figures, any text in the figures following an underscore is understood to be formatted as a subscript and is expressed as a subscript in the text of this disclosure. As such, τ_{B} shown as τ_B and τ_{A} is shown as τ_B in FIG. 10.

Ideally, the clocks of all UEs involved in the RTT positioning do not experience clock drift. In such instances, the RTT measurement is unaffected by clock drift occurring during the intervals between the transmissions and receptions of the SL-PRS. However, as a practical matter, all UEs experience clock drift. The clock drift can be modeled as \hat{τ}=(1−e)τ, where \hat{τ} is the actual measurement of a duration τ using a clock having an unknown deviation e from the ideal time due to clock drift. (For purposes of the following discussion, the unknown deviation e for a clock of a given UE (e.g., UE-A) is designated as e_{A}). As such, the measured RTT time \hat{T}_{RTT} differs from the actual RTT time T_{RTT} due to clock drift. In certain aspects, the amount of error introduced by the clock drift can be modeled as:

$$\begin{matrix}{\hat{T}}_{RTT} - {T}_{RTT} = ( {\hat{τ}}_{A} - {\hat{τ}}_{B} ) - ( {τ}_{A} - {τ}_{B} ) \\ = {e}_{A} {T}_{RTT} + ( {e}_{A} - {e}_{B} ) {τ}_{B}\end{matrix}$$

In accordance with certain aspects of the disclosure, it is noted that T_{RTT} is typically on an order of microseconds (usecs), whereas τ_{B} is on an order of milliseconds (ms), and therefore the (e_{A}−e_{B}) τ_{B} is the dominant part of the drift error. As per certain 3GPP standards, the worst-case drift tolerated for e is ±0.1 parts per million (ppm). Assuming τ_{B}=100 ms and a worst case clock drift of e_{A}−e_{B}=±0.2 ppm, the estimation error can be as high as 20 nanoseconds (nsecs), where 10 nsecs for a single-round trip propagation delay corresponds to a distance of 3 meters. In accordance with certain aspects of the disclosure, it is recognized that the impact of the clock drift error for the positioning operations shown in FIG. 10 may be reduced by selecting positioning resources that reduce the interval τ_{B} below a threshold value, where the threshold value is selected to optimize the accuracy of the positioning operations to meet system requirements. Accordingly, during resource allocation operations (e.g., the resource allocation operations shown and described with respect to FIG. 9), UE-A 1002 should reserve sidelink resources that minimize the duration of τ_{B}. To this end, the time interval between the reception of SL-PRS 1 1006 and transmission of SL-PRS 2 1008 should be no larger than a specified first time threshold Tₜₕ₁, where Tₜₕ₁ is small enough to mitigate the dominant part of the time drift error.

FIG. 11 illustrates signals exchanged during a double-sided RTT positioning procedure 1100 between sidelink UEs in accordance with certain aspects of the disclosure. In this example, three SL-PRS transmissions are used for the positioning determination. The example positioning operations again take place between UE-A 1002 and UE-B 1004, where UE-A 1002 transmits SL-PRS 1 1106, which is received by UE-B 1004 after a first time-of-flight duration TOF-1. After a time duration τ_{B,1} as measured by the UE-B's clock, UE-B in 1104 transmits SL-PRS 2 1108, which is received by UE-A 1002 after a second time-of-flight duration TOF-2. In this example, the interval between the time at which UE-A 1002 transmits SL-PRS 1 1106 and the time at which it receives SL-PRS 2 1108 from UE-B 1004 is τ_{A,1} as measured by UE-A's clock. After a time duration τ_{A,2}, UE-A 1002 transmits SL-PRS 3 1110, which is received by UE-B 1004 after a third time-of-flight duration TOF-3. The interval between the time at which UE-B 1004 transmits SL-PRS 2 1108 and the time at which UE-B 1904 receives SL-PRS 3 1110 is τ_{B,2} as measured by UE-B 1004.

Using a semi-symmetric algorithm to calculate the position of UE-A 1002 of the example in FIG. 11, results in the following clock drift error correlations:

$$\begin{matrix}{\hat{T}}_{RTT} = \frac{1}{2} ( {\hat{τ}}_{A , 1} - {\hat{τ}}_{B , 1} + {\hat{τ}}_{B , 2} - {\hat{τ}}_{A , 2} ) . \\ = \frac{{e}_{A} - {e}_{B}}{2} {T}_{RTT} + \frac{{e}_{A} - {e}_{B}}{2} ( {\hat{τ}}_{B , 1} - {\hat{τ}}_{A , 2} ) .\end{matrix}$$

Here, the term

$$\frac{{e}_{A} - {e}_{B}}{2} ( {τ}_{B , 1} - {τ}_{A , 2} )$$

constitutes the dominant portion of the clock drift error. To minimize \hat{T}_{RTT}, UE-A 1002 may reserve three sidelink resources that have a symmetric or semi-symmetric pattern such that the time interval τ_{A,2} is approximately the same as the time interval τ_{B,1}. A time pattern of sidelink resources meeting this condition occurs when |τ_{B,1}−τ_{A,2}|≤Tₜₕ₂, where Tₜₕ₂ corresponds to the maximum difference between the time intervals τ_{B,1},τ_{A,2} needed to meet a desired positioning accuracy. As an example, Tₜₕ₂ may be on the order of 3 ms to 4 ms and still obtain reasonable positioning precision. As an example, for positioning operations requiring a 1 meter (m) accuracy and having a 10% error budget, the maximum value for Tₜₕ₂ can be determined as:

$${T}_{th 2} = \frac{1 * 10 \%}{0.1 ppm * c} = 3.3 msec$$

Using an asymmetric algorithm to calculate the position of UE-A 1002 of the example in FIG. 11, results in the following determinations:

$${\hat{T}}_{RTT} = {\hat{τ}}_{A , 1} - \frac{{T}_{driftRef , A}}{{\hat{τ}}_{B , 1} + {\hat{τ}}_{B , 2}} {\hat{τ}}_{B , 1} .$$

This results in an estimation error due to clock drift corresponding to:

$${\hat{T}}_{RTT} - {T}_{RTT} = {e}_{A} {T}_{RTT} .$$

Under such conditions, the time interval between the first sidelink resource used to transmit SL-PRS 1 1106 and the last sidelink resource used to transmit SL-PRS 3 1110 should be no less than a drift-correction reference duration threshold Tₜₕ₃. The duration Tₜₕ₃ should be selected to be long enough to be effective—otherwise, the multiplicative correction factor would be a constant 1 and has no effect (e.g., {20,40,80}ms minimum SL-PRS 1 1106 to SL-PRS 2 1110) gap for timing measurement granularity of (4T_{c},8T_{c},16T_{c}) respectively. As an example, Tc can be considered as the smallest time unit that a device can count (e.g., Tc≅0.5 nsec). For a clock drift of 0.1 PPM, 20 ms (e.g., Tₜₕ₃≥20 msec) is needed to run with a 2 nsec (4Tc) difference. Otherwise, there is no difference between the denominator and numerator. This condition also applies for other granularities (e.g., 8 respectively.

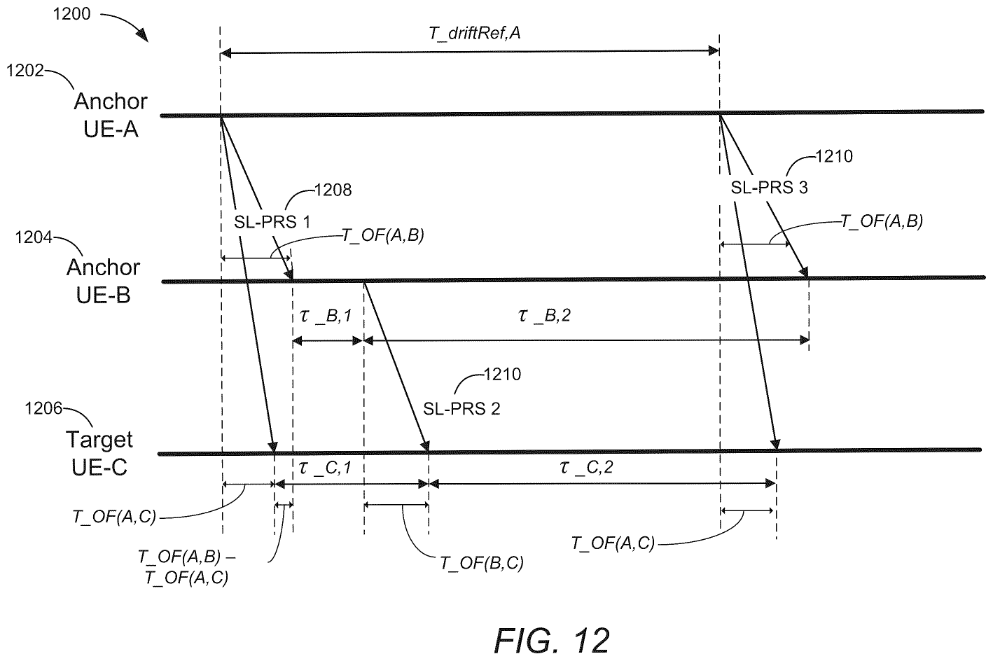

FIG. 12 illustrates signals exchanged and measured during a two-phase, reception-only time difference of arrival (Rx-TDoA) positioning procedure 1200 in accordance with certain aspects of the disclosure. The Rx-TDoA is analogous to downlink time-difference-of-arrival (DL-TDOA) in Uu in that the target UE does not transmit a SL-PRS, but rather only measures SL-PRS it receives for the positioning determination. In this example, signal transmissions and measurements take place between three sidelink devices, Anchor UE-A 1202, Anchor UE-B 1204, and Target UE-C 1206. Here, Anchor UE-A 1202 transmits SL-PRS 1 1208, which is received at Anchor UE-B 1204 after a time-of-flight T_{OF(A,B)} and at Target UE-C 1206 after a time-of-flight T_{OF(A,C)}. Similarly, Anchor UE-B 1204 transmits SL-PRS 2 1210, which is received at Target UE-C 1206 after a time-of-flight T_{OF(B,C)}. After a time interval T_{driftRef,A}, as measured by Anchor UE-A's clock, Anchor UE-A 1202 transmits SL-PRS 3 1210, which is measured at both Anchor UE-B 1204 and Target UE-C 1206.

The time intervals during which clock drift may be modeled in this example correspond to.

$$Phase 1 : {T}_{OF ( A , B )} - {T}_{OF ( A , C )} + {τ}_{B , 1} + {T}_{O F ( B , C )} = {τ}_{C , 1}$$

$$Phase 2 : {T}_{OF ( A , B )} - {T}_{OF ( A , C )} + {τ}_{C , 2} + {T}_{OF ( B , C )} = {τ}_{B , 2} .$$

The reference signal time difference of arrival, including the error resulting from clock drift, can be expressed as \hat{T}_{RSTD}, where:

$${\hat{T}}_{RSTD} = {\hat{T}}_{OF ( B , C )} - {\hat{T}}_{OF ( A , C )}$$

Applying a two-phase, symmetric/semi-symmetric algorithm to the positioning procedure 1200 results in the following clock drift error determination:

$${\hat{T}}_{RSTD} = \frac{1}{2} ( {\hat{τ}}_{C , 1} - {\hat{τ}}_{B , 1} + {\hat{τ}}_{B , 2} - {\hat{τ}}_{C , 2} ) - {T}_{OF ( A , B )} = \frac{{e}_{C} + {e}_{B}}{2} [ {T}_{OF ( A , B )} + {T}_{OF ( B , C )} - {T}_{OF ( A , C )} ] + \frac{{e}_{C} - {e}_{B}}{2} ( {τ}_{B , 1} - {τ}_{C , 2} ) .$$

Here,

$$\frac{{e}_{C} - {e}_{B}}{2} ( {τ}_{B , 1} - {τ}_{C , 2} )$$

constitutes the dominant portion of the clock drift error. As such, anchor UE-A 1202 may attempt to reserve positioning resources for transmission of SL-PRS 1 1208 and SL-PRS 2 1210 that minimize the time interval (τ_{B,1}−τ_{C,2}) and thereby reduce the impact of the clock drift error. To this end, Anchor UE-A 1202 may reserve positioning resources such that SL-PRS 2 1210 and SL-PRS 1 1208 are transmitted on positioning resources that are separated by an interval less than a minimal threshold time interval Tₜₕ₄.

Applying a two-phase, asymmetric algorithm to the positioning procedure 1200 results in the following clock drift error correlations:

$${\hat{T}}_{RSTD} = {\hat{T}}_{OF ( B , C )} - {\hat{T}}_{O F ( A , C )} = \frac{{T}_{driftRef , A}}{{\hat{τ}}_{C , 1} + {\hat{τ}}_{C , 2}} {\hat{τ}}_{C , 1} - \frac{{T}_{driftRef , A}}{{\hat{τ}}_{B , 1} + {\hat{τ}}_{B , 2}} {\hat{τ}}_{B , 1} - {T}_{OF ( A , B )} = {e}_{A} [ {T}_{OF ( A , B )} + {T}_{OF ( B , C )} - {T}_{OF ( A , C )} ] .$$

Again, under such conditions, the time interval between the first sidelink resource used to transmit SL-PRS 1 1208 and the last sidelink resource used to transmit SL-PRS 3 1210 should be no less than a drift-correction reference duration threshold Tₜₕ₅.

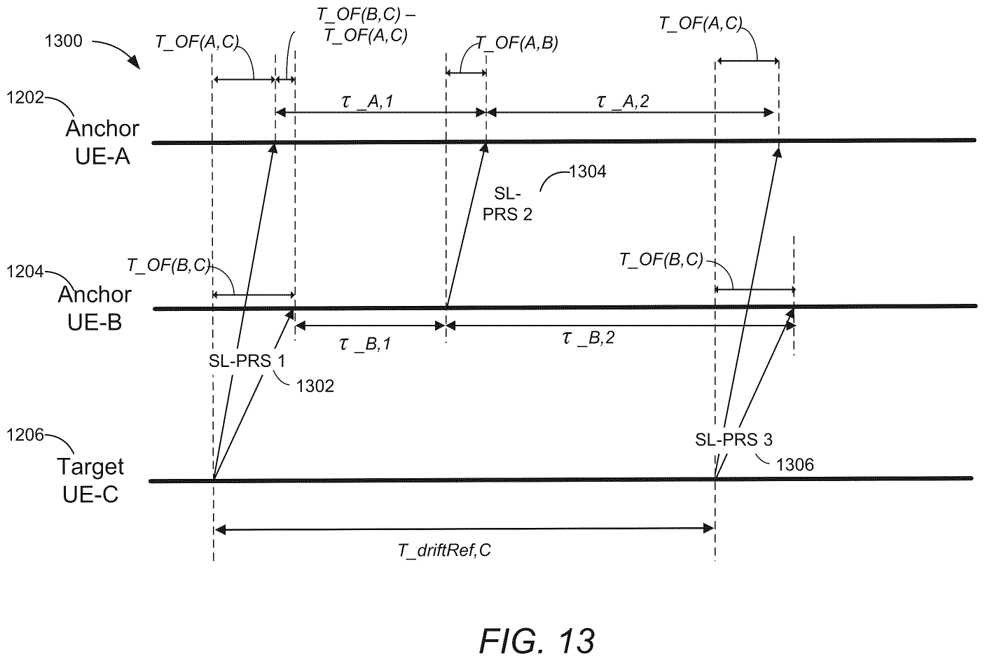

FIG. 13 illustrates signals exchanged and measured during a two-phase, transmission-only time difference of arrival (Tx-TDoA) positioning procedure 1300 in accordance with certain aspects of the disclosure. Tx-TDoA is analogous to uplink time-difference-of-arrival (UL-TDOA) using Uu in that the target UE transmits PRS that are measured by different anchor devices to determine the position of the target UE. In this example, signal transmissions and measurements again take place between three sidelink devices, Anchor UE-A 1202, Anchor UE-B 1204, and Target UE-C 1206. Here, Target UE-C 1206 transmits SL-PRS 1 1302, which is received at Anchor UE-A 1202 after a time-of-flight T_{OF(A,C)} and at Anchor UE-B 1206 after a time-of-flight T_{OF(B,C)}. Similarly. Anchor UE-B 1204 transmits SL-PRS 2 1304, which is received at Anchor UE-A 1202 after a time-of-flight T_{OF(A,B)}. After a time interval T_{driftRef,C}, as measured by Target UE-C's clock, Target UE-C 1206 transmits SL-PRS 3 1306, which is measured by both Anchor UE-A 1202 and Anchor UE-B 1204.

The time intervals during which clock drift may be modeled in this example correspond to:

$$Phase 1 : {T}_{OF ( B , C )} - {T}_{OF ( A , C )} + {τ}_{B , 1} + {T}_{OF ( A , B )} = {τ}_{A , 1}$$

$$Phase 2 : {T}_{OF ( B , C )} - {T}_{OF ( A , C )} + {τ}_{A , 2} + {T}_{OF ( A , B )} = {τ}_{B , 2} .$$

Applying a two-phase, symmetric/semi-symmetric algorithm to the positioning procedure 1300 results in the following clock drift error correlations:

$${\hat{T}}_{RSTD} = {\hat{T}}_{OF ( B , C )} - {\hat{T}}_{OF ( A , C )} = \frac{1}{2} ( {\hat{τ}}_{A , 1} - {\hat{τ}}_{B , 1} + {\hat{τ}}_{B , 2} - {\hat{τ}}_{A , 2} ) - {\hat{T}}_{OF ( A , B )} = \frac{{e}_{A} + {e}_{B}}{2} [ {T}_{OF ( A , B )} + {T}_{OF ( B , C )} - {T}_{OF ( A , C )} ] + \frac{{e}_{A} - {e}_{B}}{2} ( {τ}_{B - 1} - {τ}_{A , 2} ) .$$

Here,

$$\frac{{e}_{A} - {e}_{B}}{2} ( {τ}_{B , 1} - {τ}_{A , 2} )$$

constitutes the dominant portion of the clock drift error. As such, Target UE-C 1206 may attempt to reserve positioning resources for transmission of SL-PRS 1 1208 and SL-PRS 2 1210 that minimize the time interval (τ_{B,1}−τ_{A,2}). To this end, Target UE-C 1206 may reserve positioning resources where SL-PRS 2 1304 and SL-PRS 1 1302 are transmitted on positioning resources that are separated by an interval that is less than a minimal threshold time interval Tₜₕ₆.

Applying a two-phase, asymmetric algorithm to the positioning procedure 1300, results in the following clock drift error correlations:

$${\hat{T}}_{RSTD} = \frac{{T}_{driftRef , C}}{{\hat{τ}}_{A , 1} + {\hat{τ}}_{A , 2}} {\hat{τ}}_{A , 1} - \frac{{T}_{drftRef , C}}{{\tilde{τ}}_{B , 1} + {\hat{τ}}_{B , 2}} {\hat{τ}}_{B , 1} - {T}_{OF ( A , B )} = {e}_{C} [ {T}_{OF ( A , B )} + {T}_{OF ( B , C )} - {T}_{OF ( A , C )} ]$$

Again, under such conditions, the time interval between the first sidelink resource used to transmit SL-PRS 1 1302 and the last sidelink resource used to transmit SL-PRS 3 1306 should be no less than a drift-correction reference duration threshold Tₜₕ₇.

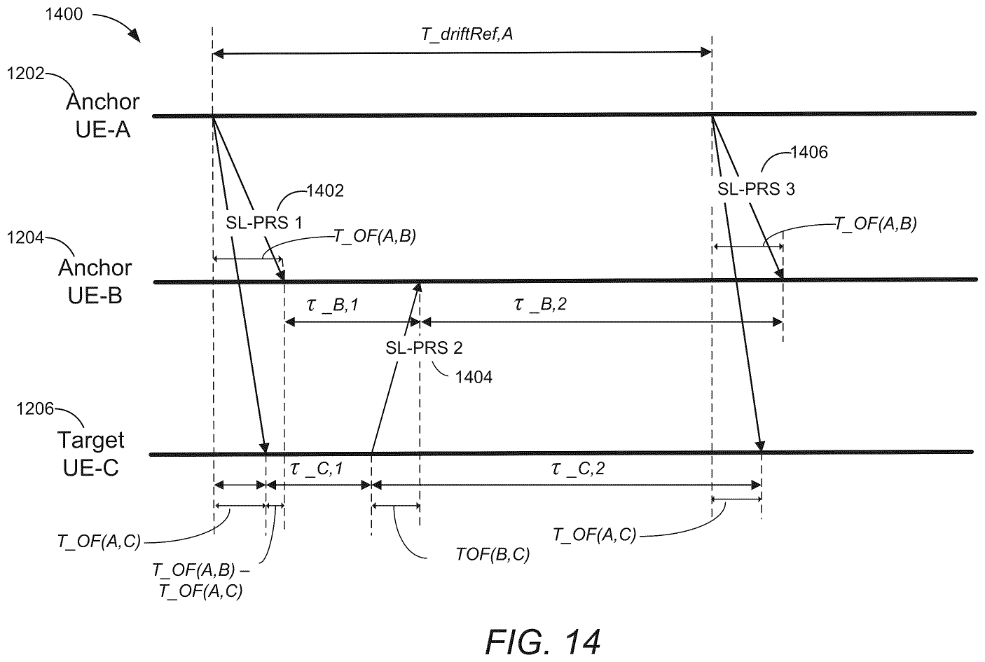

FIG. 14 illustrates signals exchanged and measured during a two-phase, elliptic positioning procedure 1400 in accordance with certain aspects of the disclosure. In this example, signal transmissions and measurements again take place between three sidelink devices, Anchor UE-A 1202, Anchor UE-B 1204, and Target UE-C 1206. Here, Anchor UE-1202 transmits SL-PRS 1 1402, which is received at Anchor UE-B 1204 after a time-of-flight T_{OF(A,B)} and a Target UE-C 1206 after a time-of-flight T_{OF(A,C)}. Similarly, Target UE-C 1206 transmits SL-PRS 2 1404, which is received at Anchor UE-B 1204 after a time-of-flight T_{OF(B,C)}. After a time interval T_{driftRef,A}, as measured by Anchor UE-A's clock, Anchor UE-A 1202 transmits SL-PRS 3 1406, which is measured at both Anchor UE-B 1204 and Target UE-C 1206.

The time intervals during which clock drift may be modeled in this example correspond to:

$$Phase 1 : {T}_{OF ( A , B )} - {T}_{oF ( A , C )} + {τ}_{B , 1} = {τ}_{C , 1} + {T}_{oF ( B , C )}$$

$$Phase 2 : {T}_{oF ( A , B )} - {T}_{o F ( A , C )} + {τ}_{C , 2} = {τ}_{B , 2} + {T}_{oF ( B , C )}$$

Applying a two-phase, symmetric/semi-symmetric algorithm to the positioning procedure 1400 results in the following clock drift error correlations:

$${\hat{T}}_{RSTD} = {\hat{T}}_{OF ( B , C )} + {\hat{T}}_{OF ( A , C )} = \frac{1}{2} ( {\hat{τ}}_{B , 1} - {\hat{τ}}_{C , 1} + {\hat{τ}}_{C , 2} - {\hat{τ}}_{B , 2} ) + {T}_{OF ( A , B )} = \frac{{e}_{B} + {e}_{C}}{2} [ {T}_{OF ( A , C )} + {T}_{OF ( B , C )} - {T}_{OF ( A , B )} ] + \frac{{e}_{B} - {e}_{C}}{2} ( {τ}_{C , 1} - {τ}_{B , 2} )$$

Here,

$$\frac{{e}_{B} - {e}_{C}}{2} ( {τ}_{C , 1} - {τ}_{B , 2} )$$

constitutes the dominant portion of the clock drift error. As such, anchor UE-A 1202 may attempt to reserve positioning resources for transmission of SL-PRS 1 1208 and SL-PRS 2 1210 that minimize the time interval (τ_{C,1}−τ_{B,2}). To this end, Anchor UE-A 1202 may reserve positioning resources such that SL-PRS 2 1404 and SL-PRS 1 1402 are transmitted on positioning resources that are spaced from one another by an interval that is less than a minimal threshold time interval Tₜₕ₈.

Applying a two-phase, asymmetric algorithm to the positioning procedure 1400 results in the following clock drift error determinations:

$${\hat{T}}_{RSTD} = {\hat{T}}_{OF ( B , C )} + {\hat{T}}_{OF ( A , C )} = \frac{{T}_{driftRef , A}}{{\hat{τ}}_{B , 1} + {\hat{τ}}_{B , 2}} {\hat{τ}}_{B , 1} - \frac{{T}_{driftRef , A}}{{\hat{τ}}_{C , 1} + {\hat{τ}}_{C , 2}} {\hat{τ}}_{C , 1} + {T}_{OF ( A , B )} = {e}_{A} [ {T}_{O F ( A , C )} + {T}_{OF ( B , C )} - {T}_{OF ( A , B )} ]$$

Again, under such conditions, the time interval between the first sidelink resource used to transmit SL-PRS 1 1402 and the last sidelink resource used to transmit SL-PRS 3 1406 should be no less than a drift-correction reference duration threshold Tₜₕ₉.

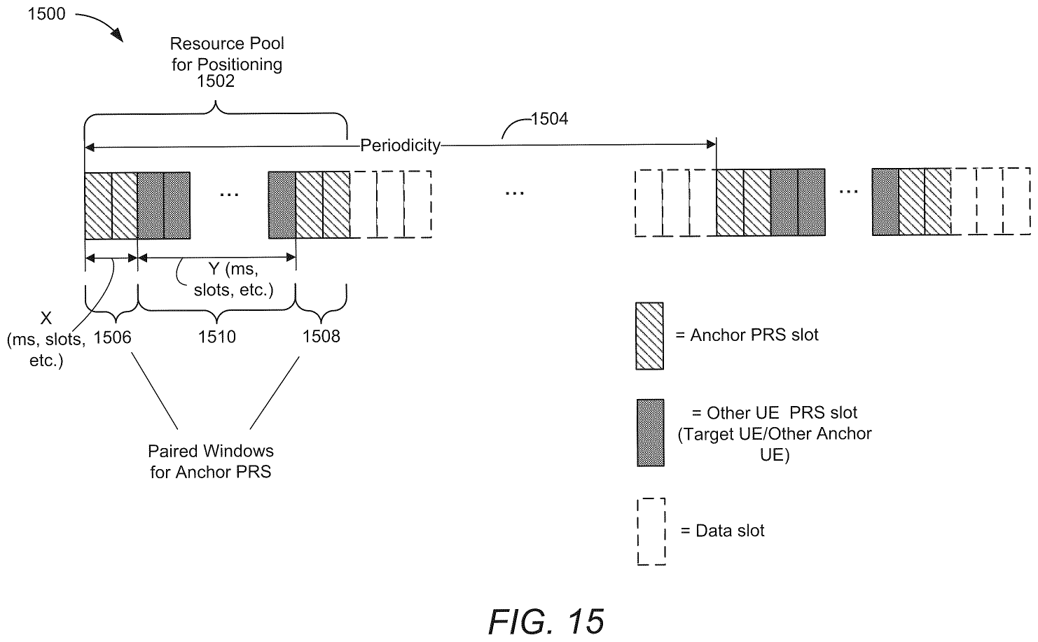

As noted herein, certain aspects of the disclosure include the use of standalone SL-PRS resources occupying the full bandwidth of a resource pool for positioning. FIG. 15 depicts a sidelink resource pool 1500, including a resource pool for positioning 1502 that occurs within the sidelink resource pool 1500 with a configurable periodicity 1504. In certain aspects, the resource pool for positioning 1502 includes a first positioning resource window 1506 having a first set of one or more contiguous positioning resources, a second positioning resource window 1508 having a second set of one or more contiguous positioning resources, and a third positioning resource window 1510 having a third set of one or more contiguous positioning resources extending between an end of the first positioning resource window 1506 and a start of the second positioning resource window 1508. In this example, the first positioning resource window 1506 and second positioning resource window 1508 are paired windows and have a configurable duration X (e.g., as measured in ms, slots, etc.), while the third positioning resource window 1510 has a configurable duration Y (e.g., as measured in ms, slots, etc.). In certain aspects, the durations X and Y are separately configured from the periodicity 1504.

In FIG. 15, the first set of one or more contiguous positioning resources of the first positioning resource window 1506 and the second set of one or more contiguous positioning resources of the second positioning resource window 1508 are dedicated for use as anchor positioning resources. The third set of one or more contiguous anchor positioning resources of the third positioning resource window 1510 are positioning resources that may be reserved for PRS transmissions of other UEs (e.g., a target UE, another anchor UE, etc.).

The sidelink positioning resource pool 1502 may be used in the positioning operations depicted in FIGS. 11, 12, and 14. During the double-sided RTT positioning procedure 1100 illustrated in FIG. 11, UE-A 1002 reserves a first positioning resource (e.g., slot) from the first positioning resource window 1506 for transmission of SL-PRS 1 1106, and a second positioning resource (e.g., slot) from the second positioning resource window 1508 for transmission of SL-PRS 3 1110. Further. UE-A 1102 reserves a third positioning resource (e.g., slot) from the third positioning resource window 1510 for transmission of SL-PRS 2 1108 by UE-B 1004. In an aspect, the positioning resources are reserved to meet the Tₜₕ₂ threshold criterion for application of a semi-synchronous positioning algorithm. If positioning resources meeting the Tₜₕ₂ threshold scenario cannot be reserved, then the interval between the first positioning resource and third positioning resource should be no less than a drift-correction reference duration threshold Tₜₕ₃. In certain aspects, the slots of the first positioning resource window 1506 are paired with slots of the second positioning resource window 1508 so that the reservations between paired slots meet the drift-correction reference duration threshold Tₜₕ₃ criterion.

With respect to the two-phase Rx-TDoA positioning procedure 1200 depicted in FIG. 12, Anchor UE-A 1202 reserves a first positioning resource (e.g., slot) from the first positioning resource window 1506 for transmission of SL-PRS 1208, and a second positioning resource (e.g., slot) from the second positioning resource window 1508 for transmission of SL-PRS 3 1210. Further, Anchor UE-A 1202 may reserve a third positioning resource (e.g., slot) from the third positioning resource window 1510 for transmission of SL-PRS 2 1210 by Anchor UE-B 1204. In this example, Target UE-C 1206 measures the SL-PRS transmitted by Anchor UE-A 1202 and Anchor UE-B 1204, and Anchor UE-B 1204 measures the SL-PRS transmitted by Anchor UE-A 1202. In an aspect, the positioning resources are reserved to meet the Tₜₕ₄ threshold criterion for application of a synchronous/semi-synchronous positioning algorithm. If positioning resources meeting the Tₜₕ₄ threshold scenario cannot be reserved, then the interval between the first positioning resource and third positioning resource should be no less than a drift-correction reference duration threshold Tₜₕ₅. In certain aspects, the slots of the first positioning resource window 1506 are paired with slots of the second positioning resource window 1508 so that the reservations between paired slots meet the drift-correction reference duration threshold Tₜₕ₅ criterion.

With respect to the two-phase, elliptic positioning procedure 1400 depicted in FIG. 14, Anchor UE-A 1202 reserves a first positioning resource (e.g., slot) from the first positioning resource window 1506 for transmission of SL-PRS 1402, and a second positioning resource (e.g., slot) from the second positioning resource window 1508 for transmission of SL-PRS 3 1406. Further, Anchor UE-A 1202 may reserve a third positioning resource (e.g., slot) from the third positioning resource window 1510 for transmission of SL-PRS 2 1404 by Target UE-C 1206. In this example, Anchor UE-B 1204 and Target UE-C 1206 measure the SL-PRS transmitted by Anchor UE-A 1202, and Anchor UE-B 1204 measures the SL-PRS transmitted by the Target UE-C 1206. In an aspect, the positioning resources are reserved to meet the Tₜₕ₆ threshold criterion for application of a synchronous/semi-synchronous positioning algorithm. If positioning resources meeting the Tₜₕ₈ threshold scenario cannot be reserved, then the interval between the first positioning resource and third positioning resource should be no less than a drift-correction reference duration threshold Tₜₕ₈. In certain aspects, the slots of the first positioning resource window 1506 are paired with slots of the second positioning resource window 1508 so that the reservations between paired slots meet the drift-correction reference duration threshold Tₜₕ₉ criterion.

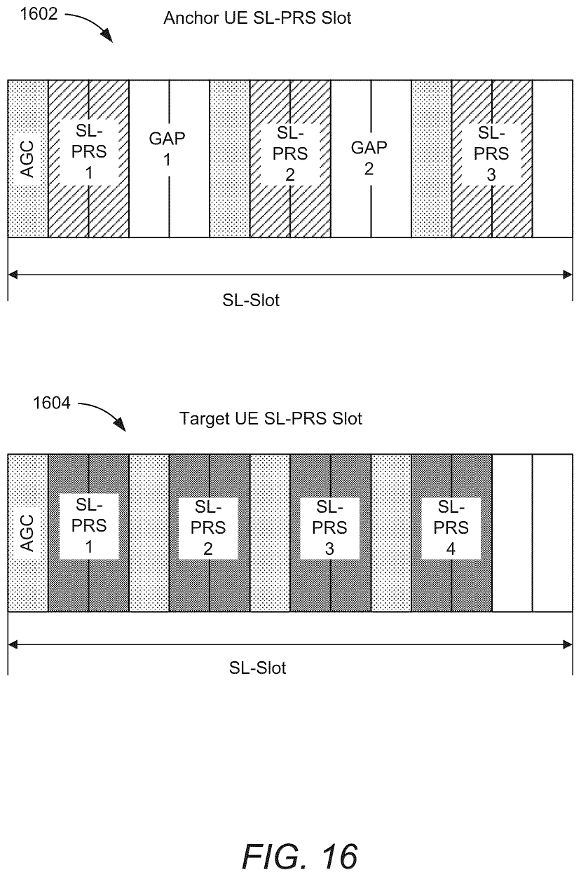

In accordance with certain aspects of the disclosure, the SL-PRS symbol patterns within a given slot may be dependent on whether the slot is dedicated for transmission of SL-PRS by an anchor UE or a target UE. FIG. 16 shows example slot configurations for SL-PRS symbols in accordance with certain aspects of the disclosure. In this example, slot configuration 1602 depicts an SL-PRS symbol pattern that may be used when the slot is configured for transmission of an SL-PRS by an anchor UE. Here, the slot configuration 1602 includes three available SL-PRS occurrences (labeled SL-PRS 1, SL-PRS 2, and SL-PRS 3) for transmission of SL PRS by an anchor UE, each having a duration of two symbols (e.g., for use with a 30 kHz SCS). The slot configuration 1602 further includes gaps (labeled GAP 1 and GAP 2) corresponding to intervals in which no symbols are transmitted by the anchor UE. In an aspect, the symbol gaps may have a duration of two symbol intervals (e.g., for use with a 30 kHz SCS) to allow the anchor UE to measure the SL-PRS transmitted from another anchor UE even in instances in which there is a loose clock synchronization between anchor UEs. Such a slot configuration may be used to support time-difference-of-arrival (TDoA) positioning operations such as shown in FIG. 12, where an anchor UE measures an SL-PRS transmitted by another anchor UE. In such instances, the anchor UE may measure the SL-PRS transmitted by one or more other anchor UE in one or more of the time gaps.

Slot configuration 1604 shows an example SL-PRS symbol pattern that may be used when the slot is configured for transmission of an SL-PRS by a target UE in accordance with certain aspects of the disclosure. Here, the slot configuration 1604 includes four available SL-PRS occurrences (labeled SL-PRS 1, SL-PRS 2, SL-PRS 3, and SL-PRS 4) for transmission of SL PRS by a target UE, each having a duration of two symbols. Unlike slot configuration 1602, the example slot configuration 1604 does not include gaps corresponding to intervals in which no symbols are transmitted by the target UE. As such, the slot configuration 1604 for transmission of an SL-PRS by a target UE may include more symbols available for SL-PRS occasions than available in the example slot configuration 1602.

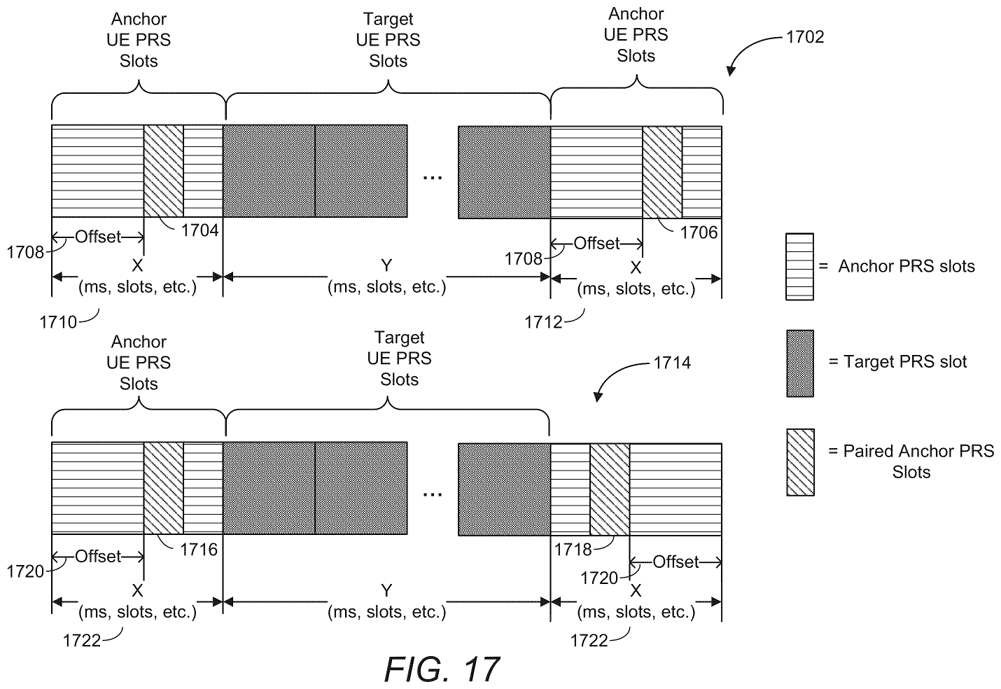

In accordance with certain aspects of the disclosure, SL-PRS resources allocated to the same anchor UE may be paired in various manners. Two examples for pairing SL-PRS resources allocated to the same anchor UE are shown in FIG. 17. Pairing 1702 shows an example in which the paired anchor UE PRS slots 1704 and 1706 occur at a same time offset interval 1708 from the start of each respective anchor positioning resource window 1710 and 1712. In accordance with certain aspects of the disclosure, the time interval X+Y in pairing 1702 satisfies (e.g., is no larger than) a threshold. As an example, for an acceptable clock drift error dominated by, for example

$$\frac{{e}_{A} - {e}_{B}}{2} ( {τ}_{B , 1} - {τ}_{A , 2} )$$

associated with the two-phase Tx-TDoA algorithm shown in FIG. 12, a 4 ms threshold corresponds to 1.2 m ranging error assuming a 10% error budget based on

$$\frac{1.2 \times 10 \%}{0.1 ppm * c} = 4 msec .$$

Pairing 1714 shows an example of paired anchor UE PRS slots 1716 and 1718, where UE PRS slot 1716 starts at an offset interval 1720 from a start of the anchor positioning resource window 1722 and the second anchor UE PRS slot 1718 is offset a time interval 1720 from the end of anchor positioning resource window 1724. In accordance with certain aspects of the disclosure, the duration of Y in pairing 1714 may be selected so that Y is no larger than a threshold.

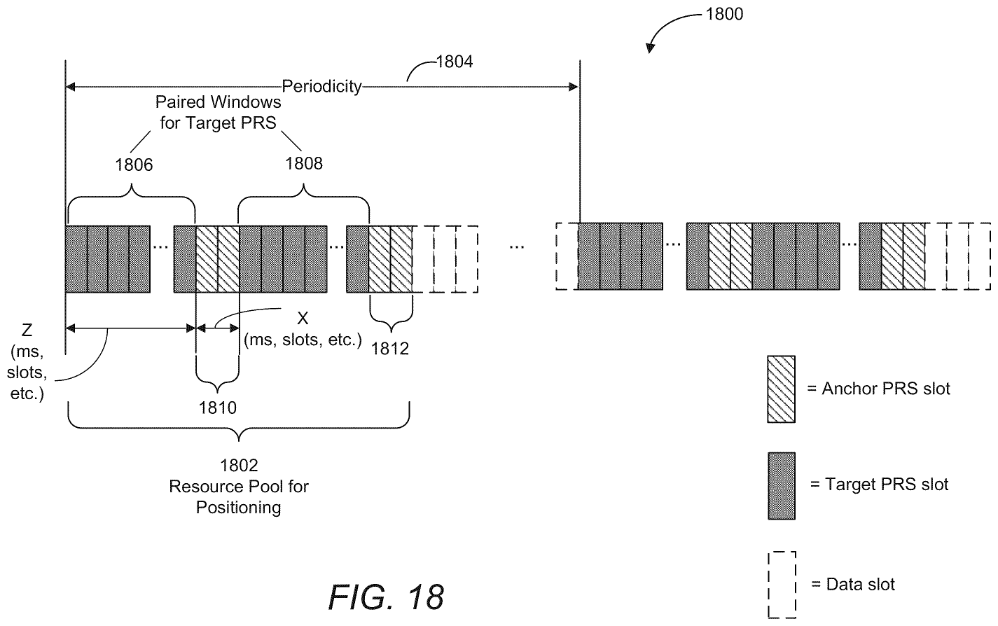

Just as anchor positioning resources may be paired, target positioning resources may also be paired in a resource pool for positioning in accordance with certain aspects of the disclosure. FIG. 18 depicts an example sidelink resource pool 1800, including a resource pool for positioning 1802 that occurs within the sidelink resource pool 1800 with a configurable periodicity 1804. In certain aspects, the resource pool for positioning 1802 includes a first positioning resource window 1806 having a first set of one or more contiguous target positioning resources, a second positioning resource window 1808 having a second set of one or more contiguous target positioning resources, and a third positioning resource window 1810 having a third set of one or more contiguous anchor positioning resources extending between an end of the first positioning resource window 1806 and a start of the second positioning resource window 1808. In accordance with certain aspects of the disclosure, the second positioning resource window 1808 may be followed by a fourth positioning resource window 1812 having a fourth set of one or more contiguous positioning resources that may be dedicated to another UE, such as an anchor UE. In this example, the first positioning resource window 1806 and second positioning resource window 1808 are paired windows and have a configurable duration Z (e.g., as measured in ms, slots, etc.), while the third positioning resource window 1810 has a configurable duration X (e.g., as measured in ms, slots, etc.). In certain aspects, the durations Z and X are separately configured from the periodicity 1804. In certain aspects, the target positioning resources within the first positioning resource window 1806 and second positioning resource window 1808 may be paired using offset configurations such as those shown in FIG. 17. Similarly, the duration of X+Z and/or X may be selected so that the duration is no larger than a threshold.

The example of the resource pool for positioning 1802 shown in FIG. 18 may be used in the allocation of positioning resources in the two-phase Tx-TDoA positioning procedure 1300 depicted in FIG. 13. In the positioning procedure are 1300, Target UE-C 1206 reserves a first positioning resource (e.g., slot) from the first positioning resource window 1806 for transmission of SL-PRS 1302, and a second positioning resource (e.g., slot) from the second positioning resource window 1808 for transmission of SL-PRS 3 1306. Further. Target UE-C 1206 may reserve a third positioning resource (e.g., slot) from the third positioning resource window 1810 for transmission of SL-PRS 2 1304 by Anchor UE-B 1204. In this example, Anchor UE-A 1202 measures the SL-PRS transmitted by Anchor UE-B 1204 and Target UE-C 1206, and Anchor UE-B 1204 measures the SL-PRS transmitted by Target UE-C 1206. In an aspect, the positioning resources are reserved to meet the Tₜₕ₆ threshold criterion for application of a synchronous/semi-synchronous positioning algorithm. If positioning resources meeting the Tₜₕ₆ threshold scenario cannot be reserved, then the interval between the first positioning resource and third positioning resource should be no less than a drift-correction reference duration threshold Tₜₕ₇. In certain aspects, the slots of the first positioning resource window 1806 are paired with slots of the second positioning resource window 1808 so that the reservations between paired slots meet the drift-correction reference duration threshold Tₜₕ₇ criterion.

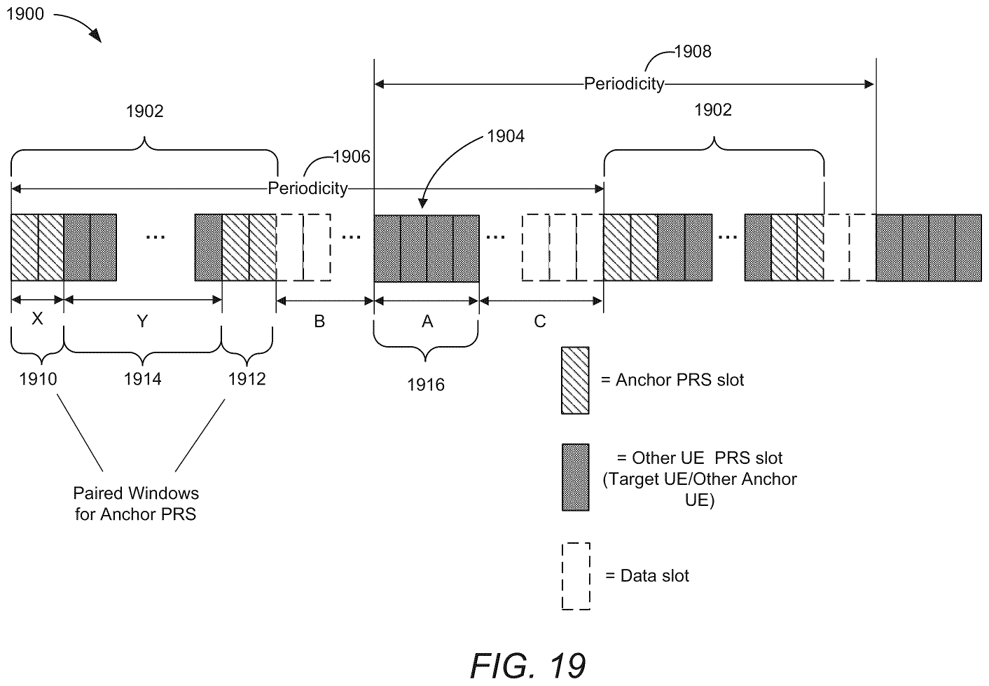

FIG. 19 depicts a sidelink resource pool 1900, including multiple resource pools for positioning 1902 and 1904 that occur within the sidelink resource pool 1900 with respective configurable periodicities 1906 and 1908. In certain aspects, the resource pool for positioning 1902 includes a first positioning resource window 1910 having a first set of one or more contiguous positioning resources, a second positioning resource window nor 1912 having a second set of one or more contiguous positioning resources, and a third positioning resource window 1914 having a third set of one or more contiguous positioning resources extending between an end of the first positioning resource window 1910 and a start of the second positioning resource window 1912. In this example, the first positioning resource window 1910 and second positioning resource window 1912 are paired windows and have a configurable duration X (e.g., as measured in ms, slots, etc.), while the third positioning resource window 1914 has a configurable duration Y (e.g., as measured in ms, slots, etc.). In certain aspects, the durations X and Y are separately configured from the periodicities 1906 and 1908.

In certain aspects, the resource pool for positioning 1904 includes a fourth positioning resource window 1916 of duration A and having a fourth set of one or more contiguous positioning resources. In this example, the fourth positioning resource window 1916 is offset from an end of the second positioning resource window 1912 by an offset interval B, and is offset from the start of the next occurrence of the resource pool for positioning 1902 by an offset interval C. In certain aspects, the duration A, offset interval B, and offset interval C may be separately configurable parameters.

The slots of the resource pool for positioning 1904 may be defined for target or anchor UEs and used for two-phase asymmetric algorithms to provide higher capacity for target/anchor SL-PRS transmissions for low-speed UEs that tolerate larger positioning latencies. In FIG. 19, the first set of one or more contiguous positioning resources of the first positioning resource window 1910 and the second set of one or more contiguous positioning resources of the second positioning resource window 1912 are dedicated for use as anchor positioning resources. The third set of one or more contiguous positioning resources of the third positioning resource window 1914 and the fourth set of one or more contiguous positioning resources of the fourth positioning resource window 1916 are positioning resources that may be reserved for SL-PRS transmissions of other anchor or target UEs, but are shown as dedicated to target UEs in this example.

In addition to the benefits associated with the ease of allocating positioning resources to mitigate clock drift errors, the disclosed resource pool(s) for positioning configurations may also be utilized by UEs to save power. In certain aspects, UEs may save power by going to a low-power mode (e.g., idle mode, sleep mode, etc.) during the consecutive slots of the resource pool for positioning in which it is not actively participating in positioning operations. For example, a target UE may go to a low-power mode during the slots allocated for target UE SL-PRS transmissions if the target UE is not required to transmit an SL-PRS. As another example, a target UE can go to a low-power mode during one or more slots dedicated to anchor UE SL-PRS if the target UE does not receive a request to measure an SL-PRS transmitted in one or more anchor UE slots. As a further example, an anchor UE can go to a low-power mode during one or more slots dedicated to target UE SL-PRS if the anchor UE does not receive a request to measure SL-PRS transmitted in the one or more slots dedicated to target UE SL-PRS. It will be recognized, based on the teachings of the present disclosure, that various power-saving configurations may be implemented that allow a UE to go to a low-power state during certain intervals of the resource pool for positioning, the foregoing constituting non-limiting examples.

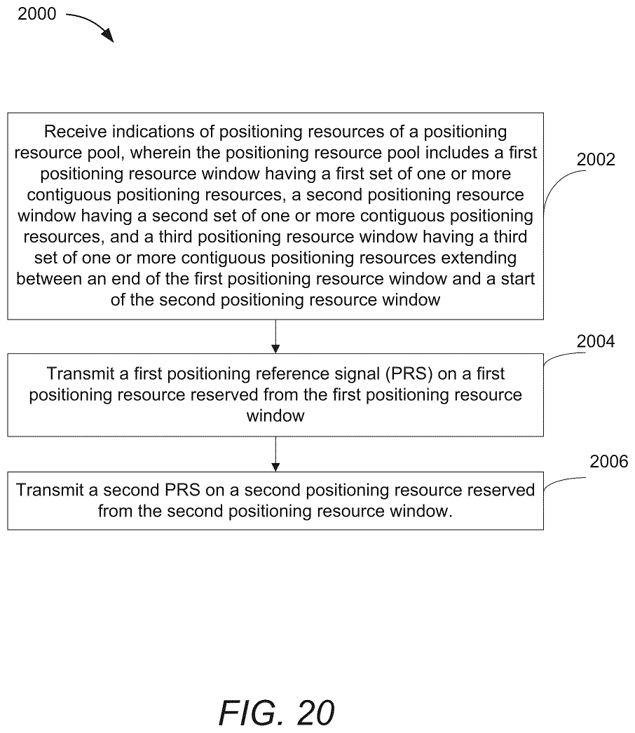

FIG. 20 illustrates an example method 2000 of wireless communication performed by a user equipment (UE) in accordance with aspects of the disclosure. At operation 2002, the UE receives indications of positioning resources of a positioning resource pool, wherein the positioning resource pool includes a first positioning resource window having a first set of one or more contiguous positioning resources, a second positioning resource window having a second set of one or more contiguous positioning resources, and a third positioning resource window having a third set of one or more contiguous positioning resources extending between an end of the first positioning resource window and a start of the second positioning resource window. In an aspect, the indications of the positioning resources of the positioning resource pool may be received from a location server, a base station (e.g., gNB), or a combination thereof. In an aspect, the indications are provided to the UE in configuration information. In an aspect, operation 2002 may be performed by the one or more transceivers 304, the one or more processors 310, memory 314, and/or sidelink manager 370, any or all of which may be considered means for performing this operation.

At operation 2004, the UE transmits a first positioning reference signal (PRS) on a first positioning resource reserved from the first positioning resource window. In an aspect, operation 2004 may be performed by the one or more transceivers 304, the one or more processors 310, memory 314, and/or sidelink manager 370, any or all of which may be considered means for performing this operation.

At operation 2006, the UE transmits a second PRS on a second positioning resource reserved from the second positioning resource window. In an aspect, operation 2006 may be performed by the one or more transceivers 304, the one or more processors 310, memory 314, and/or sidelink manager 370, any or all of which may be considered means for performing this operation.

As will be appreciated, a technical advantage of the method 2000 is the availability of greater number of positioning resources for allocation to two-phase positioning methods in which the positioning resources may be readily allocated in a manner to meet timing thresholds that mitigate the effect of clock drift errors in positioning measurements. As an example, the first positioning resource and the second positioning resource may be reserved based on a duration of time between the first positioning resource and the second positioning resource being greater than a minimum time threshold, and a third positioning resource may be reserved from the third positioning resource window for transmission of a third PRS by a further UE. The third positioning resource may be reserved based on the third positioning resource being spaced from the first positioning resource by a first time interval and from the second positioning resource by a second time interval, wherein a difference between a duration of the first time interval and a duration of the second time interval is less than a differential threshold time value. In such instances, when the UE is an anchor UE the first positioning resource and the second positioning resource may be anchor positioning resources, and the further UE is a further anchor UE. Additionally, or in the alternative, when the UE is a target UE in such instances, the first positioning resource and the second positioning resource may be target positioning resources; and the further UE is an anchor UE.

Another technical advantage is the opportunity to take advantage of timing aspects associated with certain aspects of the disclosed positioning resource configurations. For example, a UE may take advantage of the configuration of the positioning resources in the disclosed positioning resource pool(s) to save power by entering a low-power mode during certain intervals of the positioning resource pool in which the UE is not participating in positioning operations.

In the detailed description above it can be seen that different features are grouped together in examples. This manner of disclosure should not be understood as an intention that the example clauses have more features than are explicitly mentioned in each clause. Rather, the various aspects of the disclosure may include fewer than all features of an individual example clause disclosed. Therefore, the following clauses should hereby be deemed to be incorporated in the description, wherein each clause by itself can stand as a separate example. Although each dependent clause can refer in the clauses to a specific combination with one of the other clauses, the aspect(s) of that dependent clause are not limited to the specific combination. It will be appreciated that other example clauses can also include a combination of the dependent clause aspect(s) with the subject matter of any other dependent clause or independent clause or a combination of any feature with other dependent and independent clauses. The various aspects disclosed herein expressly include these combinations, unless it is explicitly expressed or can be readily inferred that a specific combination is not intended (e.g., contradictory aspects, such as defining an element as both an electrical insulator and an electrical conductor). Furthermore, it is also intended that aspects of a clause can be included in any other independent clause, even if the clause is not directly dependent on the independent clause.

Implementation examples are described in the following numbered clauses:

Clause 1. A method of wireless communication performed by a user equipment (UE), comprising: receiving indications of positioning resources of a positioning resource pool, wherein the positioning resource pool includes a first positioning resource window having a first set of one or more contiguous positioning resources, a second positioning resource window having a second set of one or more contiguous positioning resources, and a third positioning resource window having a third set of one or more contiguous positioning resources extending between an end of the first positioning resource window and a start of the second positioning resource window; transmitting a first positioning reference signal (PRS) on a first positioning resource reserved from the first positioning resource window; and transmitting a second PRS on a second positioning resource reserved from the second positioning resource window.

Clause 2. The method of clause 1, wherein: the UE is an anchor UE; and the first set of one or more contiguous positioning resources and the second set of one or more contiguous positioning resources are anchor positioning resources.

Clause 3. The method of clause 2, wherein: the third set of one or more contiguous positioning resources are target positioning resources.

Clause 4. The method of clause 1, wherein: the UE is a target UE; and the first set of one or more contiguous positioning resources and the second set of one or more contiguous positioning resources are target positioning resources.

Clause 5. The method of clause 4, wherein: the third set of one or more contiguous positioning resources are anchor positioning resources.

Clause 6. The method of any of clauses 1 to 5, further comprising: reserving the first positioning resource and the second positioning resource based on a duration of time between the first positioning resource and the second positioning resource being greater than a minimum time threshold.

Clause 7. The method of any of clauses 1 to 6, further comprising: reserving a third positioning resource from the third positioning resource window for transmission of a third PRS by a further UE.

Clause 8. The method of clause 7, further comprising: reserving the third positioning resource based on the third positioning resource being spaced from the first positioning resource by a first time interval and from the second positioning resource by a second time interval, wherein a difference between a duration of the first time interval and a duration of the second time interval is less than a differential threshold time value.

Clause 9. The method of any of clauses 7 to 8, wherein: the UE is an anchor UE; the first positioning resource and the second positioning resource are anchor positioning resources; and the further UE is a further anchor UE.

Clause 10. The method of any of clauses 7 to 8, wherein: the UE is a target UE; the first positioning resource and the second positioning resource are target positioning resources; and the further UE is an anchor UE.

Clause 11. The method of any of clauses 1 to 10, wherein: the positioning resource pool occurs on a periodic basis within a sidelink resource pool.

Clause 12. The method of clause 11, wherein: the first positioning resource window has a first window time duration; the third positioning resource window has a second window time duration; and the first window time duration and the second window time duration are configured separately from a periodicity of the positioning resource pool within the sidelink resource pool.

Clause 13. The method of any of clauses 1 to 12, wherein: the first set of one or more contiguous positioning resources are at a start of the positioning resource pool; and the second set of one or more contiguous positioning resources are at an end of the positioning resource pool.

Clause 14. The method of any of clauses 1 to 13, wherein: the first set of one or more contiguous positioning resources, the second set of one or more contiguous positioning resources, and the third set of one or more contiguous positioning resources have bandwidths spanning multiple sub-channels of the positioning resource pool.

Clause 15. The method of any of clauses 1 to 3 and 6 to 14, wherein: the UE is an anchor UE; and at least one slot of one or both of the first set of one or more contiguous positioning resources and the second set of one or more contiguous positioning resources have a slot format including an instance of a PRS symbol immediately followed by a gap having a length of one or more symbol intervals in which no symbols are transmitted.

Clause 16. The method of clause 15, further comprising: receiving a PRS from another anchor UE during the gap.

Clause 17. The method of any of clauses 1 to 16, wherein: the first positioning resource corresponds to a first slot occurring after a first time offset from a start of the first positioning resource window.

Clause 18. The method of clause 17, wherein: the second positioning resource corresponds to a first slot occurring after a second time offset from a start of the second positioning resource window, and the first time offset and the second time offset have equal values.

Clause 19. The method of any of clauses 17 to 18, wherein: the second positioning resource corresponds to a last slot occurring before a third time offset from an end of the second positioning resource window, and wherein the first time offset and the third time offset have equal values.

Clause 20. The method of any of clauses 1 to 19, wherein: the positioning resource pool further includes a fourth positioning resource window spaced in time from an end of the second positioning resource window and occurring after the second positioning resource window, and wherein the fourth positioning resource window includes a fourth set of one or more contiguous positioning resources.

Clause 21. The method of clause 20, further comprising: determining that a third positioning resource cannot be reserved from the third positioning resource window, and in response to a determination that the third positioning resource cannot be reserved from the third positioning resource window, reserving the third positioning resource from the fourth set of one or more contiguous positioning resources.

Clause 22. A user equipment (UE), comprising: a memory; at least one transceiver; and at least one processor communicatively coupled to the memory and the at least one transceiver, the at least one processor configured to: receive, via the at least one transceiver, indications of positioning resources of a positioning resource pool, wherein the positioning resource pool includes a first positioning resource window having a first set of one or more contiguous positioning resources, a second positioning resource window having a second set of one or more contiguous positioning resources, and a third positioning resource window having a third set of one or more contiguous positioning resources extending between an end of the first positioning resource window and a start of the second positioning resource window; transmit, via the at least one transceiver, a first positioning reference signal (PRS) on a first positioning resource reserved from the first positioning resource window; and transmit, via the at least one transceiver, a second PRS on a second positioning resource reserved from the second positioning resource window.

Clause 23. The UE of clause 22, wherein: the UE is an anchor UE; and the first set of one or more contiguous positioning resources and the second set of one or more contiguous positioning resources are anchor positioning resources.

Clause 24. The UE of clause 23, wherein: the third set of one or more contiguous positioning resources are target positioning resources.

Clause 25. The UE of clause 22, wherein: the UE is a target UE; and the first set of one or more contiguous positioning resources and the second set of one or more contiguous positioning resources are target positioning resources.

Clause 26. The UE of clause 25, wherein: the third set of one or more contiguous positioning resources are anchor positioning resources.

Clause 27. The UE of any of clauses 22 to 26, wherein the at least one processor is further configured to: reserve the first positioning resource and the second positioning resource based on a duration of time between the first positioning resource and the second positioning resource being greater than a minimum time threshold.

Clause 28. The UE of any of clauses 22 to 27, wherein the at least one processor is further configured to: reserve a third positioning resource from the third positioning resource window for transmission of a third PRS by a further UE.

Clause 29. The UE of clause 28, wherein the at least one processor is further configured to: reserve the third positioning resource based on the third positioning resource being spaced from the first positioning resource by a first time interval and from the second positioning resource by a second time interval, wherein a difference between a duration of the first time interval and a duration of the second time interval is less than a differential threshold time value.

Clause 30. The UE of any of clauses 28 to 29, wherein: the UE is an anchor UE; the first positioning resource and the second positioning resource are anchor positioning resources; and the further UE is a further anchor UE.

Clause 31. The UE of any of clauses 28 to 29, wherein: the UE is a target UE; the first positioning resource and the second positioning resource are target positioning resources; and the further UE is an anchor UE.

Clause 32. The UE of any of clauses 22 to 31, wherein: the positioning resource pool occurs on a periodic basis within a sidelink resource pool.

Clause 33. The UE of clause 32, wherein: the first positioning resource window has a first window time duration; the third positioning resource window has a second window time duration; and the first window time duration and the second window time duration are configured separately from a periodicity of the positioning resource pool within the sidelink resource pool.

Clause 34. The UE of any of clauses 22 to 33, wherein: the first set of one or more contiguous positioning resources are at a start of the positioning resource pool; and the second set of one or more contiguous positioning resources are at an end of the positioning resource pool.

Clause 35. The UE of any of clauses 22 to 34, wherein: the first set of one or more contiguous positioning resources, the second set of one or more contiguous positioning resources, and the third set of one or more contiguous positioning resources have bandwidths spanning multiple sub-channels of the positioning resource pool.

Clause 36. The UE of any of clauses 22 to 24, 27 to 30, and 32-35, wherein: the UE is an anchor UE; and at least one slot of one or both of the first set of one or more contiguous positioning resources and the second set of one or more contiguous positioning resources have a slot format including an instance of a PRS symbol immediately followed by a gap having a length of one or more symbol intervals in which no symbols are transmitted.

Clause 37. The UE of clause 36, wherein the at least one processor is further configured to: receive, via the at least one transceiver, a PRS from another anchor UE during the gap.

Clause 38. The UE of any of clauses 22 to 35, wherein: the first positioning resource corresponds to a first slot occurring after a first time offset from a start of the first positioning resource window.

Clause 39. The UE of clause 38, wherein: the second positioning resource corresponds to a first slot occurring after a second time offset from a start of the second positioning resource window, and the first time offset and the second time offset have equal values.

Clause 40. The UE of any of clauses 38 to 39, wherein: the second positioning resource corresponds to a last slot occurring before a third time offset from an end of the second positioning resource window, and wherein the first time offset and the third time offset have equal values.

Clause 41. The UE of any of clauses 22 to 40, wherein: the positioning resource pool further includes a fourth positioning resource window spaced in time from an end of the second positioning resource window and occurring after the second positioning resource window, and wherein the fourth positioning resource window includes a fourth set of one or more contiguous positioning resources.

Clause 42. The UE of clause 41, wherein the at least one processor is further configured to: determine that a third positioning resource cannot be reserved from the third positioning resource window; and reserve, in response to a determination that the third positioning resource cannot be reserved from the third positioning resource window, the third positioning resource from the fourth set of one or more contiguous positioning resources.

Clause 43. A user equipment (UE), comprising: means for receiving indications of positioning resources of a positioning resource pool, wherein the positioning resource pool includes a first positioning resource window having a first set of one or more contiguous positioning resources, a second positioning resource window having a second set of one or more contiguous positioning resources, and a third positioning resource window having a third set of one or more contiguous positioning resources extending between an end of the first positioning resource window and a start of the second positioning resource window; means for transmitting a first positioning reference signal (PRS) on a first positioning resource reserved from the first positioning resource window; and means for transmitting a second PRS on a second positioning resource reserved from the second positioning resource window.

Clause 44. The UE of clause 43, wherein: the UE is an anchor UE; and the first set of one or more contiguous positioning resources and the second set of one or more contiguous positioning resources are anchor positioning resources.

Clause 45. The UE of clause 44, wherein: the third set of one or more contiguous positioning resources are target positioning resources.

Clause 46. The UE of clause 43, wherein: the UE is a target UE; and the first set of one or more contiguous positioning resources and the second set of one or more contiguous positioning resources are target positioning resources.

Clause 47. The UE of clause 46, wherein: the third set of one or more contiguous positioning resources are anchor positioning resources.

Clause 48. The UE of any of clauses 43 to 47, further comprising: means for reserving the first positioning resource and the second positioning resource based on a duration of time between the first positioning resource and the second positioning resource being greater than a minimum time threshold.

Clause 49. The UE of any of clauses 43 to 48, further comprising: means for reserving a third positioning resource from the third positioning resource window for transmission of a third PRS by a further UE.

Clause 50. The UE of clause 49, further comprising: means for reserving the third positioning resource based on the third positioning resource being spaced from the first positioning resource by a first time interval and from the second positioning resource by a second time interval, wherein a difference between a duration of the first time interval and a duration of the second time interval is less than a differential threshold time value.

Clause 51. The UE of any of clauses 49 to 50, wherein: the UE is an anchor UE; the first positioning resource and the second positioning resource are anchor positioning resources; and the further UE is a further anchor UE.

Clause 52. The UE of any of clauses 49 to 50, wherein: the UE is a target UE; the first positioning resource and the second positioning resource are target positioning resources; and the further UE is an anchor UE.

Clause 53. The UE of any of clauses 43 to 52, wherein: the positioning resource pool occurs on a periodic basis within a sidelink resource pool.

Clause 54. The UE of clause 53, wherein: the first positioning resource window has a first window time duration; the third positioning resource window has a second window time duration; and the first window time duration and the second window time duration are configured separately from a periodicity of the positioning resource pool within the sidelink resource pool.

Clause 55. The UE of any of clauses 43 to 54, wherein: the first set of one or more contiguous positioning resources are at a start of the positioning resource pool; and the second set of one or more contiguous positioning resources are at an end of the positioning resource pool.

Clause 56. The UE of any of clauses 43 to 55, wherein: the first set of one or more contiguous positioning resources, the second set of one or more contiguous positioning resources, and the third set of one or more contiguous positioning resources have bandwidths spanning multiple sub-channels of the positioning resource pool.

Clause 57. The UE of any of clauses 43 to 45, 48 to 51, and 53-56, wherein: the UE is an anchor UE; and at least one slot of one or both of the first set of one or more contiguous positioning resources and the second set of one or more contiguous positioning resources have a slot format including an instance of a PRS symbol immediately followed by a gap having a length of one or more symbol intervals in which no symbols are transmitted.

Clause 58. The UE of clause 57, further comprising: means for receiving a PRS from another anchor UE during the gap.

Clause 59. The UE of any of clauses 43 to 58, wherein: the first positioning resource corresponds to a first slot occurring after a first time offset from a start of the first positioning resource window.

Clause 60. The UE of clause 59, wherein: the second positioning resource corresponds to a first slot occurring after a second time offset from a start of the second positioning resource window, and the first time offset and the second time offset have equal values.

Clause 61. The UE of any of clauses 59 to 60, wherein: the second positioning resource corresponds to a last slot occurring before a third time offset from an end of the second positioning resource window, and wherein the first time offset and the third time offset have equal values.

Clause 62. The UE of any of clauses 43 to 61, wherein: the positioning resource pool further includes a fourth positioning resource window spaced in time from an end of the second positioning resource window and occurring after the second positioning resource window, and wherein the fourth positioning resource window includes a fourth set of one or more contiguous positioning resources.

Clause 63. The UE of clause 62, further comprising: means for determining that a third positioning resource cannot be reserved from the third positioning resource window, and means for reserving the third positioning resource from the fourth set of one or more contiguous positioning resources.

Clause 64. A non-transitory computer-readable medium storing computer-executable instructions that, when executed by a user equipment (UE), cause the UE to: receive indications of positioning resources of a positioning resource pool, wherein the positioning resource pool includes a first positioning resource window having a first set of one or more contiguous positioning resources, a second positioning resource window having a second set of one or more contiguous positioning resources, and a third positioning resource window having a third set of one or more contiguous positioning resources extending between an end of the first positioning resource window and a start of the second positioning resource window; transmit a first positioning reference signal (PRS) on a first positioning resource reserved from the first positioning resource window; and transmit a second PRS on a second positioning resource reserved from the second positioning resource window.

Clause 65. The non-transitory computer-readable medium of clause 64, wherein: the UE is an anchor UE; and the first set of one or more contiguous positioning resources and the second set of one or more contiguous positioning resources are anchor positioning resources.

Clause 66. The non-transitory computer-readable medium of clause 65, wherein: the third set of one or more contiguous positioning resources are target positioning resources.

Clause 67. The non-transitory computer-readable medium of clause 64, wherein: the UE is a target UE; and the first set of one or more contiguous positioning resources and the second set of one or more contiguous positioning resources are target positioning resources.

Clause 68. The non-transitory computer-readable medium of clause 67, wherein: the third set of one or more contiguous positioning resources are anchor positioning resources.

Clause 69. The non-transitory computer-readable medium of any of clauses 64 to 68, further comprising computer-executable instructions that, when executed by the UE, cause the UE to: reserve the first positioning resource and the second positioning resource based on a duration of time between the first positioning resource and the second positioning resource being greater than a minimum time threshold.

Clause 70. The non-transitory computer-readable medium of any of clauses 64 to 69, further comprising computer-executable instructions that, when executed by the UE, cause the UE to: reserve a third positioning resource from the third positioning resource window for transmission of a third PRS by a further UE.

Clause 71. The non-transitory computer-readable medium of clause 70, further comprising computer-executable instructions that, when executed by the UE, cause the UE to: reserve the third positioning resource based on the third positioning resource being spaced from the first positioning resource by a first time interval and from the second positioning resource by a second time interval, wherein a difference between a duration of the first time interval and a duration of the second time interval is less than a differential threshold time value.

Clause 72. The non-transitory computer-readable medium of any of clauses 70 to 71, wherein: the UE is an anchor UE; the first positioning resource and the second positioning resource are anchor positioning resources; and the further UE is a further anchor UE.

Clause 73. The non-transitory computer-readable medium of any of clauses 70 to 71, wherein: the UE is a target UE; the first positioning resource and the second positioning resource are target positioning resources; and the further UE is an anchor UE.

Clause 74. The non-transitory computer-readable medium of any of clauses 64 to 73, wherein: the positioning resource pool occurs on a periodic basis within a sidelink resource pool.

Clause 75. The non-transitory computer-readable medium of clause 74, wherein: the first positioning resource window has a first window time duration; the third positioning resource window has a second window time duration; and the first window time duration and the second window time duration are configured separately from a periodicity of the positioning resource pool within the sidelink resource pool.

Clause 76. The non-transitory computer-readable medium of any of clauses 64 to 75, wherein: the first set of one or more contiguous positioning resources are at a start of the positioning resource pool; and the second set of one or more contiguous positioning resources are at an end of the positioning resource pool.

Clause 77. The non-transitory computer-readable medium of any of clauses 64 to 76, wherein: the first set of one or more contiguous positioning resources, the second set of one or more contiguous positioning resources, and the third set of one or more contiguous positioning resources have bandwidths spanning multiple sub-channels of the positioning resource pool.

Clause 78. The non-transitory computer-readable medium of any of clauses 64 to 66, 68-72, and 74-77, wherein: the UE is an anchor UE; and at least one slot of one or both of the first set of one or more contiguous positioning resources and the second set of one or more contiguous positioning resources have a slot format including an instance of a PRS symbol immediately followed by a gap having a length of one or more symbol intervals in which no symbols are transmitted.

Clause 79. The non-transitory computer-readable medium of clause 78, further comprising computer-executable instructions that, when executed by the UE, cause the UE to: receive a PRS from another anchor UE during the gap.

Clause 80. The non-transitory computer-readable medium of any of clauses 64 to 79, wherein: the first positioning resource corresponds to a first slot occurring after a first time offset from a start of the first positioning resource window.

Clause 81. The non-transitory computer-readable medium of clause 80, wherein: the second positioning resource corresponds to a first slot occurring after a second time offset from a start of the second positioning resource window, and the first time offset and the second time offset have equal values.

Clause 82. The non-transitory computer-readable medium of any of clauses 80 to 81, wherein: the second positioning resource corresponds to a last slot occurring before a third time offset from an end of the second positioning resource window, and wherein the first time offset and the third time offset have equal values.

Clause 83. The non-transitory computer-readable medium of any of clauses 64 to 82, wherein: the positioning resource pool further includes a fourth positioning resource window spaced in time from an end of the second positioning resource window and occurring after the second positioning resource window, and wherein the fourth positioning resource window includes a fourth set of one or more contiguous positioning resources.

Clause 84. The non-transitory computer-readable medium of clause 83, further comprising computer-executable instructions that, when executed by the UE, cause the UE to: determine that a third positioning resource cannot be reserved from the third positioning resource window; and reserve the third positioning resource from the fourth set of one or more contiguous positioning resources.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a general purpose processor, a DSP, an ASIC, a FPGA, or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, for example, a combination of a DSP and a microprocessor, a plurality of microprocessors, one or more microprocessors in conjunction with a DSP core, or any other such configuration.

The methods, sequences and/or algorithms described in connection with the aspects disclosed herein may be embodied directly in hardware, in a software module executed by a processor, or in a combination of the two. A software module may reside in random access memory (RAM), flash memory, read-only memory (ROM), erasable programmable ROM (EPROM), electrically erasable programmable ROM (EEPROM), registers, hard disk, a removable disk, a CD-ROM, or any other form of storage medium known in the art. An example storage medium is coupled to the processor such that the processor can read information from, and write information to, the storage medium. In the alternative, the storage medium may be integral to the processor. The processor and the storage medium may reside in an ASIC. The ASIC may reside in a user terminal (e.g., UE). In the alternative, the processor and the storage medium may reside as discrete components in a user terminal.

In one or more example aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

While the foregoing disclosure shows illustrative aspects of the disclosure, it should be noted that various changes and modifications could be made herein without departing from the scope of the disclosure as defined by the appended claims. The functions, steps and/or actions of the method claims in accordance with the aspects of the disclosure described herein need not be performed in any particular order. Furthermore, although elements of the disclosure may be described or claimed in the singular, the plural is contemplated unless limitation to the singular is explicitly stated.

What is claimed is:

1. A method of wireless communication performed by a user equipment (UE), comprising:
receiving indications of positioning resources of a positioning resource pool, wherein the positioning resource pool includes a first positioning resource window having a first set of one or more contiguous positioning resources, a second positioning resource window having a second set of one or more contiguous positioning resources, and a third positioning resource window having a third set of one or more contiguous positioning resources extending between an end of the first positioning resource window and a start of the second positioning resource window;
transmitting a first positioning reference signal (PRS) on a first positioning resource reserved from the first positioning resource window; and
transmitting a second PRS on a second positioning resource reserved from the second positioning resource window.

2. The method of claim 1, wherein:
the indications of positioning resources are received from a location server, a base station, or combination thereof.

3. The method of claim 1, wherein:
the indications of positioning resources are received in configuration information.

4. The method of claim 1, wherein:
the UE is an anchor UE; and
the first set of one or more contiguous positioning resources and the second set of one or more contiguous positioning resources are anchor positioning resources.

5. The method of claim 2, wherein:
the third set of one or more contiguous positioning resources are target positioning resources.

6. The method of claim 1, wherein:
the UE is a target UE; and
the first set of one or more contiguous positioning resources and the second set of one or more contiguous positioning resources are target positioning resources.

7. The method of claim 6, wherein:
the third set of one or more contiguous positioning resources are anchor positioning resources.

8. The method of claim 1, further comprising:
reserving the first positioning resource and the second positioning resource based on a duration of time between the first positioning resource and the second positioning resource being greater than a minimum time threshold.

9. The method of claim 1, further comprising:
reserving a third positioning resource from the third positioning resource window for transmission of a third PRS by a further UE.

10. The method of claim 9, further comprising:
reserving the third positioning resource based on the third positioning resource being spaced from the first positioning resource by a first time interval and from the second positioning resource by a second time interval, wherein a difference between a duration of the first time interval and a duration of the second time interval is less than a differential threshold time value.

11. The method of claim 9, wherein:
the UE is an anchor UE;
the first positioning resource and the second positioning resource are anchor positioning resources; and
the further UE is a further anchor UE.

12. The method of claim 9, wherein:
the UE is a target UE;
the first positioning resource and the second positioning resource are target positioning resources; and
the further UE is an anchor UE.

13. The method of claim 1, wherein:
the positioning resource pool occurs on a periodic basis within a sidelink resource pool.

14. The method of claim 13, wherein:
the first positioning resource window has a first window time duration;
the third positioning resource window has a second window time duration; and
the first window time duration and the second window time duration are configured separately from a periodicity of the positioning resource pool within the sidelink resource pool.

15. The method of claim 1, wherein:
the first set of one or more contiguous positioning resources are at a start of the positioning resource pool; and
the second set of one or more contiguous positioning resources are at an end of the positioning resource pool.

16. The method of claim 1, wherein:
the first set of one or more contiguous positioning resources, the second set of one or more contiguous positioning resources, and the third set of one or more contiguous positioning resources have bandwidths spanning multiple sub-channels of the positioning resource pool.

17. The method of claim 1, wherein:
the UE is an anchor UE; and
at least one slot of one or both of the first set of one or more contiguous positioning resources and the second set of one or more contiguous positioning resources have a slot format including an instance of a PRS symbol immediately followed by a gap having a length of one or more symbol intervals in which no symbols are transmitted.

18. The method of claim 17, further comprising:
receiving a PRS from another anchor UE during the gap.

19. The method of claim 1, wherein:
the first positioning resource corresponds to a first slot occurring after a first time offset from a start of the first positioning resource window.

20. The method of claim 19, wherein:
the second positioning resource corresponds to a first slot occurring after a second time offset from a start of the second positioning resource window, and the first time offset and the second time offset have equal values.

21. The method of claim 19, wherein:
the second positioning resource corresponds to a last slot occurring before a third time offset from an end of the second positioning resource window, and wherein the first time offset and the third time offset have equal values.

22. The method of claim 1, wherein:
the positioning resource pool further includes a fourth positioning resource window spaced in time from an end of the second positioning resource window and occurring after the second positioning resource window, and wherein the fourth positioning resource window includes a fourth set of one or more contiguous positioning resources.

23. The method of claim 22, further comprising:
determining that a third positioning resource cannot be reserved from the third positioning resource window; and
in response to a determination that the third positioning resource cannot be reserved from the third positioning resource window, reserving the third positioning resource from the fourth set of one or more contiguous positioning resources.

24. A user equipment (UE), comprising:
a memory;
at least one transceiver; and
at least one processor communicatively coupled to the memory and the at least one transceiver, the at least one processor configured to:
receive, via the at least one transceiver, indications of positioning resources of a positioning resource pool, wherein the positioning resource pool includes a first positioning resource window having a first set of one or more contiguous positioning resources, a second positioning resource window having a second set of one or more contiguous positioning resources, and a third positioning resource window having a third set of one or more contiguous positioning resources extending between an end of the first positioning resource window and a start of the second positioning resource window;
transmit, via the at least one transceiver, a first positioning reference signal (PRS) on a first positioning resource reserved from the first positioning resource window; and
transmit, via the at least one transceiver, a second PRS on a second positioning resource reserved from the second positioning resource window.

25. The UE of claim 24, wherein:
the indications of positioning resources are received from a location server, a base station, or combination thereof.

26. The UE of claim 24, wherein:
the indications of positioning resources are received in configuration information.

27. The UE of claim 24, wherein:
the UE is an anchor UE; and
the first set of one or more contiguous positioning resources and the second set of one or more contiguous positioning resources are anchor positioning resources.

28. The UE of claim 24, wherein:
the third set of one or more contiguous positioning resources are target positioning resources.

29. The UE of claim 24, wherein:
the UE is a target UE; and
the first set of one or more contiguous positioning resources and the second set of one or more contiguous positioning resources are target positioning resources.

30. The UE of claim 29, wherein:
the third set of one or more contiguous positioning resources are anchor positioning resources.

31. The UE of claim 24, wherein the at least one processor is further configured to:
reserve the first positioning resource and the second positioning resource based on a duration of time between the first positioning resource and the second positioning resource being greater than a minimum time threshold.

32. The UE of claim 24, wherein the at least one processor is further configured to:
reserve a third positioning resource from the third positioning resource window for transmission of a third PRS by a further UE.

33. A user equipment (UE), comprising:
means for receiving indications of positioning resources of a positioning resource pool, wherein the positioning resource pool includes a first positioning resource window having a first set of one or more contiguous positioning resources, a second positioning resource window having a second set of one or more contiguous positioning resources, and a third positioning resource window having a third set of one or more contiguous positioning resources extending between an end of the first positioning resource window and a start of the second positioning resource window;
means for transmitting a first positioning reference signal (PRS) on a first positioning resource reserved from the first positioning resource window; and
means for transmitting a second PRS on a second positioning resource reserved from the second positioning resource window.

34. A non-transitory computer-readable medium storing computer-executable instructions that, when executed by a user equipment (UE), cause the UE to:
receive indications of positioning resources of a positioning resource pool, wherein the positioning resource pool includes a first positioning resource window having a first set of one or more contiguous positioning resources, a second positioning resource window having a second set of one or more contiguous positioning resources, and a third positioning resource window having a third set of one or more contiguous positioning resources extending between an end of the first positioning resource window and a start of the second positioning resource window;
transmit a first positioning reference signal (PRS) on a first positioning resource reserved from the first positioning resource window; and
transmit a second PRS on a second positioning resource reserved from the second positioning resource window.
